(19) United States
(12) Patent Application Publication
(10) Pub. No.: US 2009/0118849 A1
(43) Pub. Date: May 7, 2009

(54) AUTOMATED VENDING-TYPE STUDIO RECORDING FACILITY

(76) Inventors: SHIMON DERY, Oakland Park, FL (US); OLEG CHERNOBRODSKY, Miami, FL (US)

Correspondence Address: LOZA & LOZA LLP, 305 N. Second Avenue, #127, Upland, CA, 91786-6064, US

(21) Appl. No.: 12/263,461

(22) Filed: Nov. 1, 2008

Related U.S. Application Data
(60) Provisional application No. 61/001,731, filed on Nov. 2, 2007.

(51) Int. Cl. G06F 17/00

(52) U.S. Cl. 700/94

(57) ABSTRACT

The present invention is an improved portable automated recording facility and method of use thereof. In particular, the present invention relates to a self-contained, self-operated and fully automated audio/video recording and production system. The preferred embodiment of the invention comprises an external shell having sound-dampening material to dampen sound from the entering or exiting the facility. The facility contains a recording chamber including a removable recording equipment module having multi-track recording equipment and a disk media recording device connected to a user system interface. The facility is preferably connected to an external network such as the Internet and has external media connectors for uploading and downloading recordings to or from users. A plurality of facilities can be networked together at a central server so they can be, inter alia, monitored for maintenance data, receive software upgrades, access media in a database, or be used to remotely conduct a performance contest.

### CLAIM OF PRIORITY UNDER 35 U.S.C. §119

The present Application for patent claims priority to Provisional Application No. 61/001,731 filed Nov. 2, 2007, and assigned to the assignee hereof and hereby expressly incorporated by reference herein.

### FIELD

At least one feature relates to an improved automated recording facility and method of use thereof. In particular, a self-contained, self-operated and fully automated audio/video recording and production system is disclosed including, but not limited to, a method of use and computer program product.

### BACKGROUND

Self-contained audio and video recording systems in which a user is able to perform a song or other performance by paying money via a vending-type system and receive a compact disc of the user's performance at the conclusion of recording are known in the art. However, the inability of such systems to emulate common studio functionality, features, production quality, and provide users with functionality that can accommodate diverse recording tasks (e.g., not limited to karaoke, or internal media, or a single recorded performance, or a single production of recorded performance, or a single layer as opposed to a merged multi-layered recording composition, or basic editing features) in an efficient, automated, unattended, and simplified manner, contributes to the lack of popularity and availability of such systems as a useful studio-type vending system. Accordingly, such vending-type systems are labeled as recording systems or karaoke studios and are basic in nature. Thus, conventional vending-type recording and/or production systems are unable to deliver and/or emulate and/or unify various recording-studio functionalities to achieve diverse and/or merged multi-layered recordings for audio/video production while also providing an automated system by which an average user can easily compose, edit, record, reproduce, transfer files (to various media, platforms and/or external devices and/or via wireless transmission or the Internet), and create merged multi-track composition(s) (“a multi-layered composition”) without the use of a studio engineer/attendant, an overly complex interface and/or an overly complex process.

### SUMMARY

An improved portable automated recording facility and method of use thereof is provided. In particular, at least one aspect relates to a self-contained, self-operated and fully automated audio/video recording and production system. The preferred embodiment of the invention comprises an external shell having sound-dampening material to dampen sound from the entering or exiting the facility. The facility contains a recording chamber including a removable recording equipment module having multi-track recording equipment and a disk media recording device connected to a user system interface. The facility is preferably connected to an external network such as the Internet and has external media connectors for uploading and downloading recordings to or from users. A plurality of facilities can be networked together at a central server so they can be, inter alia, monitored for maintenance data, receive software upgrades, access media in a database, or be used to remotely conduct a performance contest.

In one example, the portable automated recording facility may be implemented as a vending-type recording studio kiosk. The vending-type recording studio kiosk may include an external shell, a user system interface, and/or a multifunctional module. The vending-type recording studio kiosk may include an external shell, a user system interface, and/or a multifunctional module. The external shell may have sound-dampening material and define an interior recording chamber. The user system interface may provide instructions to users and/or receive user selections. The user system interface may be integrated as part of the multifunctional module and may provide multilingual support for instructions and/or selections in audio and visual forms. The multifunctional module may be located within the recording chamber and controlled via the user system interface. The multifunctional module may be removable and interchangeable with another multifunctional module. The user system interface and multifunction module may be adapted to allow a user to automatically record single and multi-layered audio compositions. The multifunctional module may include a processing module that may be configured to: (a) capture a plurality of audio tracks from a user (e.g., via an audio capture device), and/or (b) sequentially merge a currently captured audio track with one or more previously captured audio tracks in a user-controlled continuous loop where the one or more previously captured audio tracks are played to the user concurrent with capturing the current audio track from the user to thereby create an automatically engineered merged multi-layered audio composition. The continuously looped merging process auto-unifies the currently captured and the one or more previously captured audio tracks in a multi-layering operation. The multifunctional module may be configured to provide step-by-step interactive instructions to allow an untrained user to perform automated end-to-end audio capture, merging, and production. The multifunctional module may also be configured to reverse the merger of the currently captured audio track and one or more previously captured audio tracks based on user selections.

The one or more of the captured audio tracks may be merged with at least one of: pre-recorded audio by one or more users, an uploaded audio recording, and a captured video track. The multifunctional module may be further configured to play (via audio output device, e.g., headphones) the one or more previously captured audio (e.g., stored in storage device) while performing the looped audio capture and thereby automatically aligning the currently captured audio track with the one or more previously captured audio tracks prior to merging into the combined multi-layered composition. The currently captured audio track may be edited according to user selections prior to merging with the one or more previously captured audio tracks to obtain the multi-layered composition.

According to various examples, the merging of the currently captured audio track with the one or more previously captured audio tracks includes at least one of: (a) concurrently capturing a vocal track while merging the captured vocal track with one or more other vocal tracks to create the combined multi-layered composition, (b) concurrently capturing a vocal track while merging the captured vocal track with one or more pre-recorded captured instrumental tracks to create the combined multi-layered composition, (c) concurrently capturing an instrumental-type audio track while merging the captured instrumental-type audio track with one or more pre-recorded capture vocal tracks to create the combined multi-layered composition, (d) concurrently capturing an audio track while merging the captured audio track with a pre-stored karaoke-type tune to create the combined multi-layered composition, and/or (e) concurrently capturing an audio portion of an audio-video track while merging the audio portion with the plurality of previously captured audio tracks to create the combined multi-layered composition. The two or more merged tracks may be created by the same user or by different users. Consequently, the kiosk may be fully automated and operable to capture and record audio, review audio recordings, delete unwanted audio recordings, loop and merge the captured audio, and cancel merging of multiple captured audio tracks.

According to yet another feature, the multifunctional module may include (a) a recording device (e.g., audio capture device) to capture the one or more previously captured audio tracks, (b) an editing device to edit the captured audio tracks according to user selections, and/or (c) a vending apparatus to collect payment from the user for use of the recording studio kiosk.

The multifunctional module may also include (a) a disk media recording device adapted to record one or more multi-layered audio compositions into a removable recording medium, (b) a network interface through which captured audio can be stored offsite, and/or (c) a communication port to couple to a removable storage device on which captured audio can be stored and from which user-provided audio can be uploaded.

Additionally, an audio-video capture device may be located within the recording chamber and coupled to the multifunctional module to capture audio and video, wherein an audio portion of an audio-video track captured by the audio-video capture device is automatically merged with a previously recorded multi-layered audio composition to produce an audio-video composition with a multi-layered audio composition.

A video display may be located on the outside of the external shell to display at least one of a captured user performance and instructional information for potential users. Additionally, an exterior user interface may be provided where recording options can be selected and previewed prior to entering the recording chamber. This allows users to minimize their time within the recording chamber, thereby allowing more users to use the recording studio kiosk.

The kiosk may also include a network interface to couple the multifunctional module to an external network and allow storage of the multi-layered composition to a central server. The multifunctional module may also be configured to allow a user to download at least one of: music selections, pre-recorded audio, user-provided audio, and audio recorded by other users via the network interface.

The multifunctional module may also be configured to collect at least one of: sales information for the kiosk, recording statistics for the kiosk, and/or music selection information for the kiosk that can be used to make profit sharing and royalty payments.

### BRIEF DESCRIPTION OF THE DRAWINGS

FIG. 1 is a perspective view of an automated recording facility according to an embodiment of the present invention.

FIG. 2 is a perspective view of an automated recording facility according to an embodiment of the present invention.

FIG. 3 is a perspective view of a component module used in an embodiment of the present invention.

FIG. 4 is a perspective view of an automated recording facility according to an embodiment of the present invention with a component module removed from the automated recording facility.

FIG. 5 is a block diagram of an embodiment of the present invention.

FIG. 6 is a block diagram of an embodiment of the present invention.

FIGS. 7A-7B show a flow chart describing a recording process of an embodiment of the present invention.

FIG. 8A-8D are a flow chart describing a recording process of an embodiment of the present invention.

FIG. 9 illustrates a screen shot of a menu displayed by an embodiment of the present invention.

FIG. 10 illustrates a screen shot of a menu displayed by an embodiment of the present invention.

FIG. 11 illustrates a screen shot of a menu displayed by an embodiment of the present invention.

FIG. 12 illustrates a screen shot of a menu displayed by an embodiment of the present invention.

FIG. 13 illustrates a screen shot of a menu displayed by an embodiment of the present invention.

FIG. 14 illustrates a screen shot of a menu displayed by an embodiment of the present invention.

FIG. 15 illustrates a screen shot of a menu displayed by an embodiment of the present invention.

FIG. 16 illustrates a screen shot of a menu displayed by an embodiment of the present invention.

FIG. 17 illustrates a screen shot of a menu displayed by an embodiment of the present invention.

FIG. 18 illustrates a screen shot of a menu displayed by an embodiment of the present invention.

FIG. 19 is a flow chart describing the auto-multi-track merge function (automation of a traditional multi-tracking and track mixdown process) of an embodiment of the present invention.

FIG. 20 illustrates a screen shot of a menu displayed by an embodiment of the present invention.

FIG. 21 illustrates a screen shot of a menu displayed by an embodiment of the present invention.

FIG. 22 illustrates a screen shot of a menu displayed by an embodiment of the present invention.

FIG. 23 is a flow chart describing a process of downloading/transmitting recordings created by an embodiment of the present invention.

FIG. 24 illustrates a screen shot of a menu displayed by an embodiment of the present invention.

FIG. 25 illustrates a screen shot of a menu displayed by an embodiment of the present invention.

FIG. 26 illustrates a screen shot of a menu displayed by an embodiment of the present invention.

FIG. 27 is a block diagram of a computer.

FIG. 28 is a block diagram illustrating an example of a vending-type recording studio kiosk.

FIG. 29 illustrates a method for operating a vending-type recording studio kiosk. A user selection for a recording session is obtained.

### DETAILED DESCRIPTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide an improved automated recording facility and a method of use thereof.

### Mobile Automated Recording Facility or Kiosk

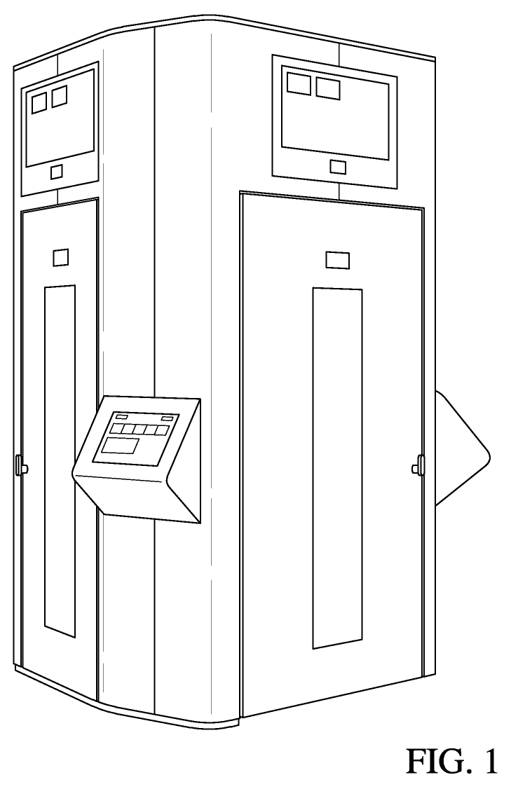

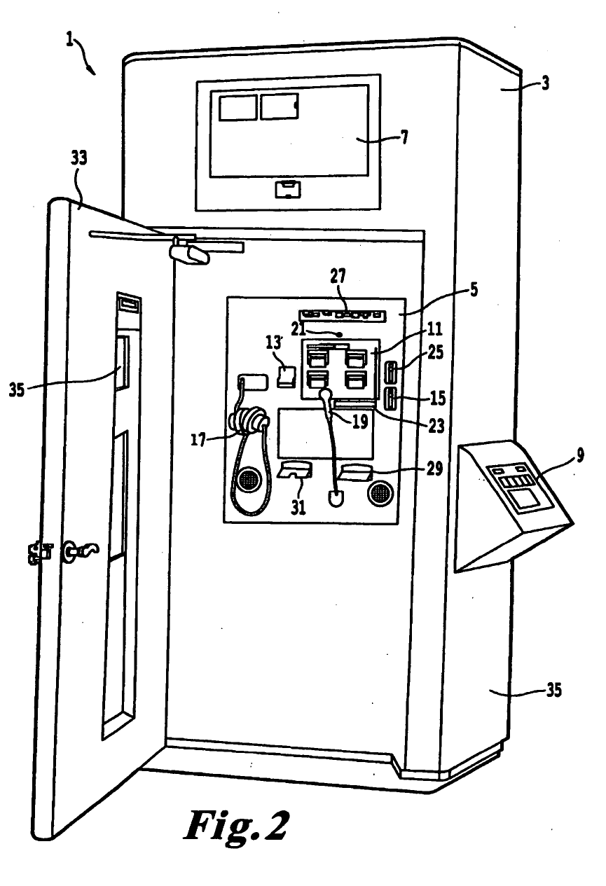

FIG. 1 is a perspective view of an example of an automated recording facility. Details of the components and features of an automated recording facility 1 are shown and will be described with reference to FIG. 2. The automated recording facility 1 may include an interior portion accessible by way of a doorway. A user of the facility 1 enters the facility 1 and by way of the controls and features of the software and hardware in the facility 1 is able to produce a studio quality audio and/or video production without the need for (or assistance from) a professional studio engineer. As seen from the exterior of the facility 1, one or more external displays 7 are visible to observers on the outside of the facility 1 who may either want to observe the conduct of a user inside the facility 1 or see other information presented on the display such as advertisements, descriptions of how the system operates, etc. Furthermore, at about waist level, a product information and song preview center 9 may serve as a user interface for one or more of the external observers. These external observers may have the option of using a touch panel display on the preview center 9 to preselect potential songs, rhythms, beats, or other features that the observer may choose to use when it is that observer's time to enter the facility 1. The preview center 9 can include, for example, a touch panel display that provides for an interactive graphical user interface for two-way communications with the facility 1. Optionally, a keyboard, keypad, or pointing device (e.g., mouse, track ball, etc.) may be used as an alternative to the touch panel display.

A feature of the facility 1 is that it is packaged as a portable device that may be delivered on site to different locations, for example, at a party or a corporate event. The facility 1 may be delivered by a rental service or leasing service for use at the temporary location for a limited period of time. Connections for both electrical and communication conductivity are provided through external connection ports on the facility 1. In remote locations, the facility 1 is equipped to operate on battery power and include wireless communication capability for providing conductivity at remote locations. Examples of wireless conductivity capabilities include cellular communications, radio frequency communications, microphone communications, infrared communications and space based digital communication services such as through the Iridium service. Other connection possibilities include Wireless Local Area Networks (WLAN), IEEE 802.11 (WiFi), Wireless Metropolitan Area Networks (WMAN), and Broadband Fixed Access (BWA, IMDS, WiMax, and HIPERMAN). As such, the facility 1 may be used on mobile platforms such as cruise ships and trains as entertainment services. Because the facility 1 is a self-contained portable installation, the business uses of the facility 1 are diverse. Consequently, the facility's portability and its ability to transmit data can allow the public to utilize the facility in a variety of environments, record performances, and transmit/transfer said performances to a variety of media and/or the Internet for others to hear and/or view.

An example of how the present invention can be used is as follows: A promoter can place a facility 1 at multiple locations. The resulting audio and/or video recordings from the multiple locations can then be transmitted to another site where the recordings are aggregated and reviewed by the promoter. Thus, singers in different cities could participate in a talent contest that is remotely judged by the promoter. Furthermore, the promoter could have a set of facilities 1 located in a first city during a first month, where different amateur users record multi-track recordings that are then submitted for review to the promoter. Thus, during the first month, the promoter will receive only talent submissions from amateurs at the first city. The promoter then may review all the submissions and select a subset for use in the promoter's event. During a second month, a set of facilities 1 could be deployed to a second city to gather the recordings of users in that second city. Those recordings could then be judged as above.

FIG. 2 is a perspective view of a preferred embodiment of some of the primary features of the facility 1. The facility 1 preferably has an exterior shell 3 made from a suitable material or materials. The facility 1 shown in FIG. 2 includes soundproof material used in the construction of the exterior shell 3. Preferably, the exterior shell 3 has an outer metallic or fiberglass layer and a sound insulating material on an interior side of the exterior shell 3. The facility 1 may preferably have an interior panel comprising sound absorbing properties. The facility 1 has an interior portion, where the surface of the interior portion has sound absorbing materials formed as a component shell 5. Various components (as will be described below) may be mounted on, and/or integrated into, the interior component shell 5. However, as previously discussed with regard to FIG. 1, an external display 7 may be mounted on the exterior shell 3, so that observers who are not yet making recordings in the facility 1 may either view advertisements, instructions, or have a video view of the user(s) of the facility 1.

Alternately, the external display 7 could display a video of the artist originally performing the song currently being performed by the user of the facility 1. By way of example only, the user of facility 1 could record a performance of the song, “Mrs. Robinson”, while viewers of external display 7 watch a performance by Paul Simon of the song “Mrs. Robinson.”

The facility 1 may further comprise a product information and/or song preview center 9. The song preview center 9 is preferably located in two different locations on the exterior shell 3 of the facility 1. The product information and song preview center 9 is located at about waist height on the exterior shell 3 and is preferably wheelchair accessible. The product information and song preview center 9 allows a user to preliminarily view information such as songs and other system capabilities. Also, a user can preselect information used in recording via the product information and song preview center 9. The song preview center 9 may reduce the time spent by the user inside the facility 1 by allowing preliminary information to be saved when the user is outside and another user is recording inside the facility 1. This enables more users to use the automated recording facility 1.

The facility 1 may preferably have a system interface 11 located within its interior. The system interface 11 can be, for example, a touch screen, a keyboard, a track ball, or other means of input by which a user can control the automated recording facility 1. The system interface 11 is preferably located at a user's typical standing eye level and displays various means by which the user can control the automated recording facility 1 during the recording process. For example, the system interface 11 displays screens by which the user can control the recording process.

The recording facility 1 may also comprise a cash acceptor 13. The cash acceptor 13 allows a user to pay for a recording session with currency. Preferably, the facility 1 further comprises a credit card acceptor 15 located next to the system interface 11. The acceptor 15 allows a user to pay for a session using a credit card or debit card.

Headphones 17 and a microphone 19 may be located within the facility 1 shown in FIG. 2. The headphones 17 allow a user to more clearly hear their performance and the background music, if any. Also, the headphones 17 may screen the user from extraneous noises while inside the facility 1. Furthermore, headphones 17 are preferably used to monitor the recording (as opposed to using speakers) and reduce the incidence of feedback and negative funnel-type effects through the microphone 19. The microphone 19 is preferably highly adjustable for the various heights of different users. For example, the microphone 19 should adjustable to accommodate both a standing user or to a lower setting so that a person in a wheelchair or a seated individual is able to record comfortably and with the microphone placed at an optimal position.

The preferred embodiment in FIG. 2 may further comprise a camera 21 located slightly above the system interface 11. The camera 21 provides for the video recording of an individual(s) performing inside the facility 1. Because the camera 21 is located very close to the system interface 11, when a user reads lyrics displayed on the system interface 11, the eyes of a typical performer are approximately at camera level. Thus, ideally, when a user performs karaoke, it appears as though the performer is not reading off the screen but is rather looking straight into the camera.

The facility 1 may also preferably comprise within the component shell 5 a CD/DVD drive 23 that allows a user to insert a CD or DVD with prerecorded information. The CD/DVD drive 23 allows a user to access a song that may not be contained on a database 41 or hard drive 8 or otherwise accessible by the facility 1. External device inputs 25 are also preferably included in the component shell 5 of the automated recording facility 1. External device inputs 25 (e.g., communication input/output interfaces) may allow a user to connect an external media device such as an iPod®, MP3 player, flash disk, or some other storage device to the automated recording facility 1. The external device inputs 25 can include USB connectors, IEEE 1394 connectors, Toslink connectors, RCA connectors, or other audio/data input connectors.

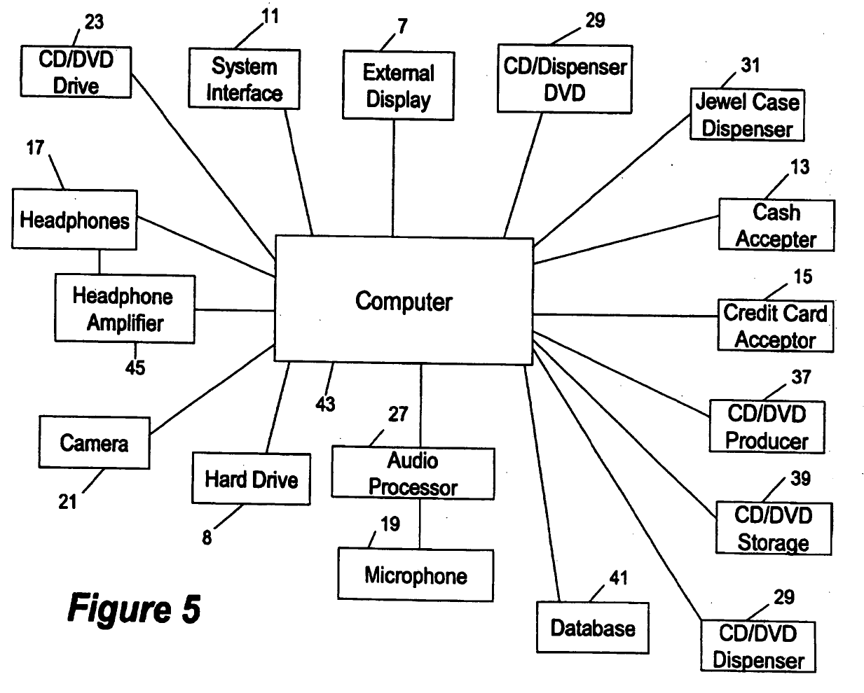

Referring now to the preferred embodiment shown in FIG. 5, an audio processor 27 is located in the component shell 5 and allows for editing, mixing, and adjusting vocals from a performance within the facility 1. The audio processor 27 communicates with a computer 43. Further, the audio processor 27 allows for the adjustment of different frequencies such as bass frequencies and treble frequencies in order to customize a given performance.

The facility further preferably comprises a CD/DVD dispenser 29. The CD/DVD dispenser 29 is located in the component shell 5 and allows for the production of a CD or DVD. Also located next to the CD/DVD dispenser 29 is a jewel case dispenser 31, which dispenses a CD/DVD jewel case. The case can be customized using additional software operated by the system interface 11. Thus, the user can make custom CD or DVD cases that denote the user's recording performance and protect the finished product from debris and scratches. An alternate embodiment of the present invention may also utilize advanced robotics for CD/DVD production and dispensing. Specifically, robotics can be utilized for internally transferring recording media (CD/DVD) from mass storage areas to a CD surface printer, to production, and to the output bin. Robotics can also be used to print custom labels based on the user input, directly onto the surface of a CD/DVD.

The exterior shell 3 of the facility 1 includes a main door 33 that swings outward and enables easy access for users entering and exiting the facility 1. Preferably, the main door 33 opens wide enough for a wheelchair to navigate into the facility 1. The main door 33 preferably includes windows 35. The windows 35 are located on the main door 33 and also on the sides of the exterior shell 3. Windows 35 allow individuals located outside of the recording facility 1 to view a performer inside of the facility 1. Thus, a parent can monitor young children while the children are performing inside the booth. The windows 35 may preferably include automatic curtains that can be operated by the push of a button to screen an individual recording within the facility 1. The automated curtains can be shutters, blinds, fabric, or any other means by which the windows 35 can be covered. Another advantage of using glass on the sidewalls and doors is to reduce the possible occurrence of user claustrophobia while still providing noise reduction characteristics.

The exterior shell 3 is preferably made of a weather resistant material such as metal, fiberglass, plastic, composite, or some other material which allows the exterior shell 3 to be resist weather conditions, thus allowing the facility 1 to be placed at an outdoor location such as an amusement park, a fair, or some other outdoor event or locale. The facility 1 preferably includes a cooling system used to provide a comfortable environment in which a user can perform their recording and also providing a cool environment even when the facility 1 is located outdoors and not within a climate controlled building.

The climate control system may be preferably a heating, ventilation, and air-conditioning system (HVAC). The climate control system can also be used to cool equipment. The exterior panels and/or materials of the recording module 1 are preferably made of materials that can withstand various vending environments such as high-temperature conditions, low-temperature conditions, rain and/or snow.

The interior of the recording module 1 may preferably have a cleared-floor design that allows a user to perform with musical instruments, accommodates multiple users, accommodates the handicapped, allows dancing while performing, and encourages standing while singing (providing a better vocal performance).

In addition, the recording module 1 preferably has wheels, or some other mechanism that allows the recording module to be easily transported. The recording module is preferably comprises multiple components that can be quickly and easily assembled and disassembled.

### Removable Component Shell

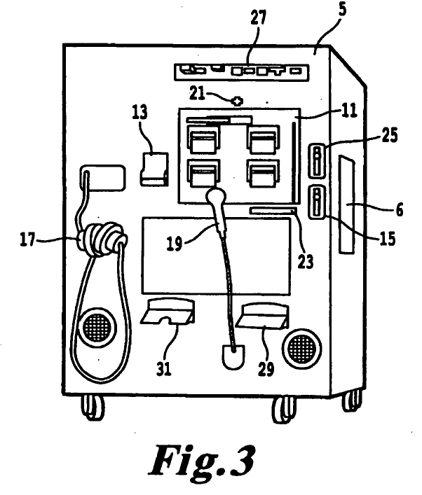

FIG. 3 is a perspective view of the component shell 5. FIG. 3 shows the component shell 5 (e.g., multifunctional module) removed from the exterior shell 3 and the inside of the automated recording facility 1. Because the component shell 5 may be easily removed from the rest of the facility 1, maintenance is more easily performed. If there is a malfunction, a maintenance technician can simply remove the component shell 5 from the exterior shell 3 and then put in a new component shell 5 in the exterior shell 3 on site, and then can repair the malfunctioning component shell remotely. Thus, any downtime associated with a malfunction of the automated recording facility 1 is minimized. The component shell 5 also eliminates the need to diagnose problems at the vending-sites, and reduces the need for specialized technicians on site. The component shell 5 preferably does not require the exterior shell 3 in order to operate and is functional as a stand alone unit. Also, it is possible to insert the component shell 5 into alternate shells or environments where the component shell 5 can still fully function and operate. Also, the component shell 5 contains a power/data interface 6 that includes audio/video input/output and computer/network/Internet connections that are used to connect the component shell 5 to the exterior shell 3 or directly to audio/video or network connections.

FIG. 3 also illustrates that the component shell 5 may be packaged as a portable device that may be delivered on site to different locations, for example, at a party or a corporate event. The component shell 5 may be delivered by a rental service or leasing service for use at the temporary location for a limited period of time. Connections for both electrical and communication conductivity are provided through external connection ports on the component shell 5. In remote locations, the component shell 5 may be equipped to operate on battery power and include wireless communication capability for providing conductivity at remote locations. Examples of wireless conductivity capabilities include cellular communications, radio frequency communications, microphone communications, infrared communications and space based digital communication services such as through the Iridium service. Other connection possibilities include Wireless Local Area Networks (WLAN), IEEE 802.11 (WiFi), Wireless Metropolitan Area Networks (WMAN), and Broadband Fixed Access (BWA, IMDS, WiMax, and HIPERMAN). As such, the component shell 5 may be used on mobile platforms such as cruise ships and trains as entertainment services. Because the facility 1 is a self-contained portable installation, the business uses of the facility 1 are diverse. Consequently, the component shell's portability and its ability to transmit data can allow the public to utilize the facility in a variety of environments, record performances, and transmit/transfer said performances to a variety of media and/or the Internet for others to hear and/or view.

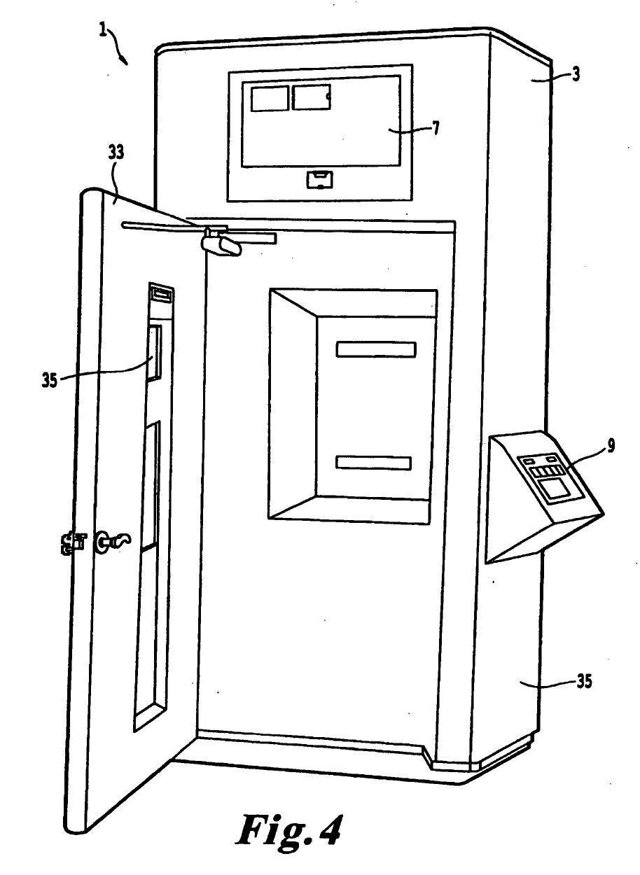

Turning now to FIG. 4, FIG. 4 is a perspective view of the facility 1 with the component shell 5 removed from the exterior shell 3. The compartment shown in FIG. 4 holds the component shell 5 and includes an input/output connection interface by which power and data are transmitted from the exterior shell 3 via the power/data interface 6 to the component shell 5 as described above.

### Recording Facility Operation

FIG. 5 is a diagram of the various components connected to or contained within the facility 1. FIG. 5 shows the different ways in which these components are connected and communicate with each other. A computer 43 is shown in the middle of FIG. 5 and is connected to the various components used when operating the facility 1. The components shown in FIG. 5 are preferably located within the component shell 5 though a subset of the components may be contained in the exterior shell 3 portion of the facility 1. The system interface 11 is connected to the computer 43. In addition, the external display 7 is connected to the computer 43. The CD/DVD dispenser 29 is connected to and communicates with the computer 43. The jewel case dispenser 31 is connected to the computer 43. The cash acceptor 13 and the credit card acceptor 15 are also connected to the computer 43. The CD/DVD producer 37 is shown in FIG. 5 and the CD/DVD producer 37 burns the user's recording onto a CD or DVD in the CD/DVD Drive 23. The CD/DVD producer 37 can burn data onto a variety of formats including but not limited to CD-R/CD-RW, DVD-R, and DVD-RW. A CD/DVD storage device 39 communicates with the computer 43. The CD/DVD storage 39 contains blank recordable media and a robotic\transport mechanism to transfer the blank recordable media to the CD/DVD producer 37 where a CD or DVD is created with the user's recording on it. After the CD/DVD producer 37 has created a CD or DVD, the CD/DVD dispenser 29 and the jewel case dispenser 31 output the CD(s)/DVD(s) and jewel case(s) to the user. The system preferably utilizes the robotic\transport mechanism of the CD/DVD dispenser 29 and jewel case dispenser 31 to conveys the CD or DVD and jewel case(s) to the user.

Also shown in FIG. 5 is a database 41. The database 41 is connected to the computer 43 and preferably contains songs, instrumentals, beats, or any other type of music or sounds that can be used in making a recording. The database 41 can communicate with computer 43 via a network or wirelessly. The database 41 is preferably included within the automated recording facility 1 but might alternately be located remotely. An advantage of having the database 41 located in a location remote to the facility 1 is the size of the automated recording facility 1 can be reduced. It is also envisioned that multiple databases 41 could be connected to the computer 43. The database 41 could also be used as a storage unit where a user could store their completed recordings. This would provide an alternative to producing a hard copy of their performance on a DVD or CD. For example, the user could store their recording on the database 41 and then login to the database via a website, access their saved recording, and upload their recording to their personal computer at home (or some other device or location). Also connected to the computer 43 is the audio processor 27. The audio processor 27 is used to enhance the user's recording by providing editing features and can be used to adjust various parameters of a user's recording. For example, the user could adjust and boost different frequencies of the recording such as the treble, the midrange, or the bass frequencies. Also, a user could use the audio processor 27 to modify the pitch of the vocals, or slow down or speed up the playback rate of the recording.

The microphone 19 is connected to the audio processor 27, which is in turn connected to the computer 43. The camera 21 is also connected to the computer 43. The computer 43 is able to control the different functions of the camera 21. Preferably, the computer 43 can be used to zoom the camera's lens or focus the camera's lens to follow the user's movements. Preferably, the computer 43 uses motion sensors and/or infrared sensors or other methods to control the camera's view of the user. The computer 43 also controls the camera's recording functions such as stop, record, rewind, and fast-forward. Once a user has performed and has obtained a video recording of their performance, the computer 43 can manipulate the video data to provide different backgrounds and different visual effects to a user's video recording. Thus, the user's video recording can be combined with a multi-layered audio composition (using the auto-multi-track function).

The headphones 17 are preferably connected to a headphone amplifier 45, which is in turn connected to the computer 43. The headphone amplifier 45 amplifies the audio signal received from the computer 43 and sends the signal to the headphones 17.

### Network of Recording Facilities and Infrastructure

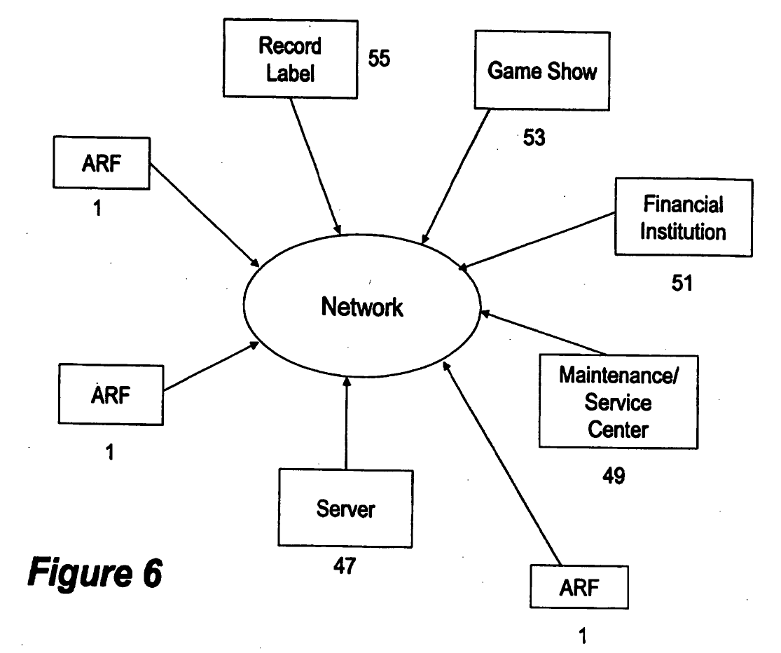

Turning now to FIG. 6, FIG. 6 shows a diagram of how various automated recording facilities 1 can interface with other entities and devices via a network. FIG. 6 shows multiple recording facilities 1 which can be located in various different locations. For example, one facility 1 could be located within a shopping mall and another facility 1 could be located at an amusement park in a different state. However, the multiple automated recording facilities 1 are networked so that they can communicate with each other and/or can upload/download information to/from a common location such as a server 47. Thus, even though several facilities 1 can be located in different locations, they can have access to the same information held on the server 47 via a network, allowing several different users of various recording facilities 1 located in different locations to submit musical compositions to the same central locale. For example, individuals competing in a talent show could record performances at different recording facilities 1 located throughout the country and submit performances to one common server 47 electronically. Also shown in FIG. 6 is a maintenance/service center 49. The maintenance/service center 49 is connected to various facilities 1 via the network and receives messages and error notifications relating to a particular facility 1. Also, the maintenance/service center 49 could send software updates to the facilities 1 over the network. The facilities 1 can send a message electronically to the service center 49 when there is a malfunction and then a technician can be dispatched to the location where the reporting facility 1 is located. This decreases the amount of time a recording facility 1 is inoperable by decreasing the amount of time it takes a technician to learn of the malfunction and thus reducing the amount of time it takes to make the repair.

Supervisory functions can also be managed by the automated recording facility 1. The automated recording facility 1 is capable of generating various reports that are useful for monitoring maintenance issues. Thus, when there is a maintenance issue, management personnel in charge of the automated recording facility is promptly notified, and a technician can be rapidly dispatched. Also, various types of data (e.g. income of the machine, statistics of usage, error reports, etc.) can be digitally retrieved from the system via the Internet, or locally, by opening a password controlled supervisor panel and attaching a USB based mini-drive (or any other storage device) to the external device inputs 25. Maintenance personnel then type in a password, and press a button to transfer the appropriate system-generated report to the storage device connected to the external device input 25. The password used to access the supervisor panel is controlled by a variable-based password system (e.g. the password automatically changes periodically). Thus, the password is never the same with each attempt of opening the supervisor panel. For scheduled system maintenance, a password is given/dispatched to maintenance personnel by the maintenance/service center 49 associated with the automated recording facility 1, and will only work during a limited time frame.

The password is preferably generated at the maintenance/service center 49 using an automated recording facility management-software tool that generates password codes based on the proper management-identity password, and required system information. The manner in which these password codes are generated is preferably concealed even from management. If a maintenance employee is no longer employed by the owners of the automated recording facilities 1, the owner of the automated recording facilities 1 will not have to update the password because the password changes automatically. This variable-password process improves system security, and also ensures timely maintenance service (since maintenance passwords only work for a limited time). Furthermore, the supervisor panel could be accessed by other individuals who are not maintenance employees (e.g. users) who call the maintenance/service center 49 to report problems with an automated recording facility 1. A password could then be given to activate restricted functionality in order to correct a system problem or to reactivate a disrupted user session. Alternately, the password given to the user will only reactivate a recording session if certain system criteria are met. Thus, the password could prevent false claims made by users that the automated recording facility 1 is malfunctioning.

Also shown in FIG. 6 is a financial institution 51. The financial institution 51 can be, for example, PayPal®, a bank, or a credit card company, etc. The financial institution 51 provides another means by which a user can pay for their recording. For example, a user could access their PayPal® account via the system interface 11 and pay for their recording electronically via the Internet. Alternately, the data from a facility 1 could also be transmitted to an Internet, radio or television program via the network. As mentioned earlier by way of example, in a talent search, various competitors can record a composition in different locations of the country and then submit their recording electronically via the system interface 11 and transmit their recording to a common destination, such as a server 47 for a game show 53. It is also possible for a user to transmit the recording over a network to a record publisher, also known as a “record label,” 55 or some other entity in the music industry. It is envisioned that other businesses or components could be linked to one or more automated recording facilities 1 via a network.

### Example Recording Process

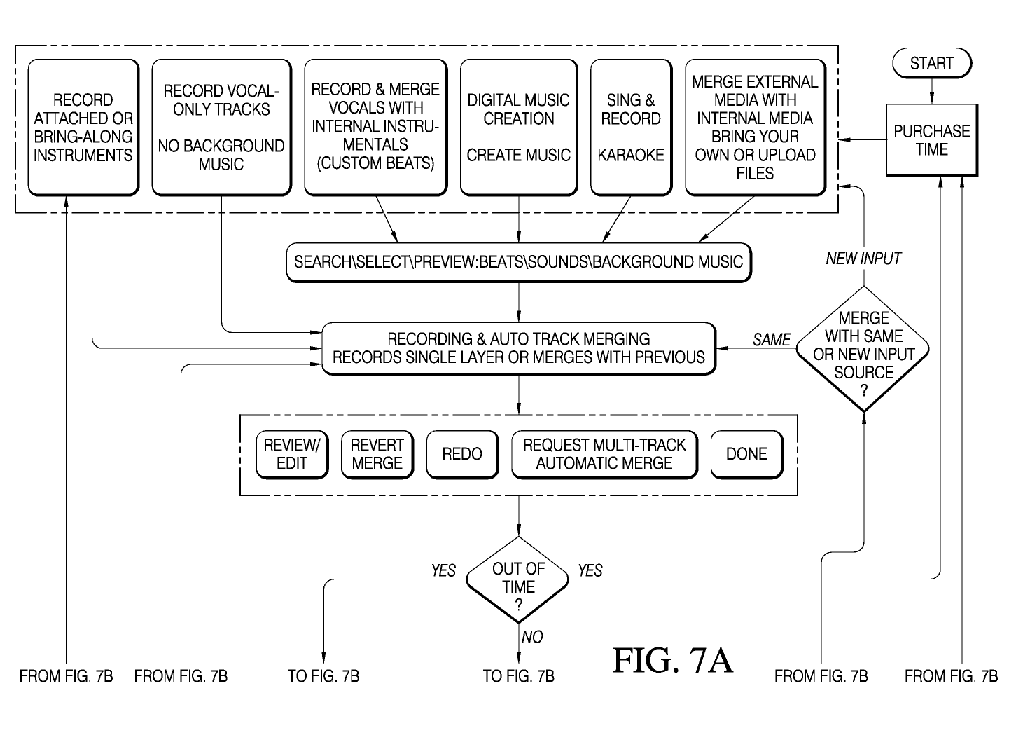

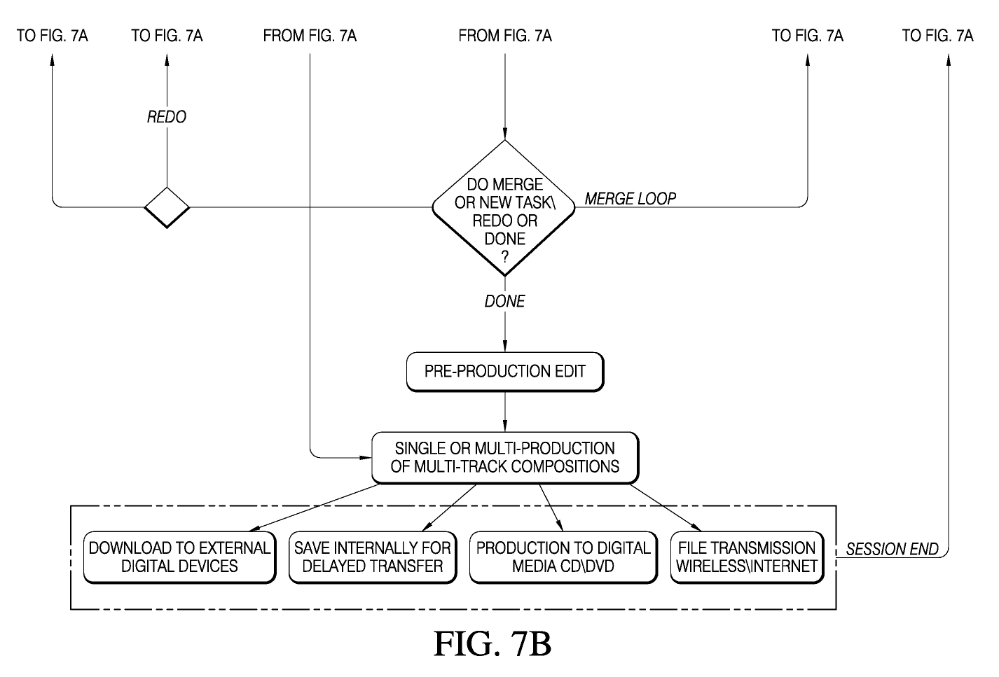

Turning now to FIGS. 7A-7B, FIGS. 7A-7B show a flow chart of the process by which a user can produce a recording of their musical performance. The process begins by a user purchasing recording time by inserting money, a credit card, tokens, a prepaid password or code, etc., into the system. Next, the user is presented with several recording options based on their preferences. For example, a user can record an instrument that they have brought along with them such as a harmonica or guitar, or a user could record a vocal-only track (e.g., a cappella), or the user may record over internal system media or external media brought by, e.g. the user, or media that is downloaded from the Internet to the facility 1 or media that could be transferred into the system by other digital/wireless means. Regardless of the method used to transfer media into the system, the software used by the system monitors for incoming media and then allows the user to use and/or manipulate such media as it does internal media.

Accordingly, the preferred embodiment of the system interface 11 displays a screen in which six options are available (other options are possible) for the user based on the recording task the user wishes to perform (e.g., sing a cappella or perform a speech, sing karaoke, sing personal lyrics over internal or external media, record an instrument or record other performances, or downloaded into the system via the Internet or other file transfer means, etc.). After a user has recorded his performance they can use the auto-track merging function (an automated process simply triggered by pressing a button on the system interface 11—such as a touch screen or other device and is a custom feature which automates the traditional and intricate multi-track recording and mix-down/merge process) in which the user can put a new recording layer on top of the recording they just performed. For example, a user could play an instrument in a first recording or “track” and then with the auto track-merging feature the user could create a second track comprising vocals that, when added to the first instrumental track, creates a single multi-track recording. After a user has used the auto-track merging function, the user has the option to review and use simplified auto-edit system features to alter the recording just performed. In addition, the user has the ability to separate tracks and go back to a first or previous recording. For example, if the user did a first track of just instrumentals and then used the auto-multi-track-merge feature to record vocals on top of the first instrumental track, and if when the user was reviewing the results of the merged recorded tracks and did not like the way it sounded, the user could separate the first and second (or more) tracks and go back to the first track which only contained instrumentals. The user could then try to redo the multi-tracked recording with new tracks or new edits of previously recorded tracks. Accordingly, if the user likes the auto track recording after reviewing their last recording, the user can request that the multiple-tracks are automatically merged. When the user merges the recording, both recordings are integrated and the resulting track will contain multiple layers of recordings in a single recording (merged multi-layered composition).

Next, once a user is done with the auto track-merge function, the system determines whether or not the user has any recording time left. As long as the user still has time left in the recording session (or the user purchases additional time), the user could either create other recording layers and/or merge these new recording layers with the previously recorded multi-layered composition or the user could advance to the pre-production edit step. In the pre-production edit step, the user can control what tracks will be included in the final production of CD/DVD and/or file(s) transfer(s) to other devices or destinations (e.g. Internet sites or email). The user can preview and delete unwanted recordings before burning or finalizing the recording to a CD or DVD or requesting a file transfer. After the pre-production edit step, the user advances to the single or multi-production step. In this step, single or multiple copies of the actual physical disk(s) is/are produced with a recording encoded thereon. For example, the CD/DVD producer 37 stores a copy of the recording(s) on a CD or DVD by burning the user's recording on it. Also, the user can download their finished recording to external storage devices such as an Ipod®, MP3 player, or a flash disk, etc. The facility 1 also preferably has the capability to save the finished recording internally on a hard drive in order to transfer the finished recording to another device or location at a later time. Further, the finished recording can be transmitted electronically over the Internet or by a wireless network. The file can be transmitted wirelessly in numerous ways, for example via Bluetooth technology, cellular network, infrared, or radio frequency. Once the user has either produced the CD/DVD, stored or transmitted their finished recording, the user can either end their session or purchase additional time and create additional recordings. If the user chooses to purchase additional time, then the process starts over again at the top of the flowchart shown in FIGS. 7A-7B, where the user once again preferably has six different options.

When a user selects the recording task of recording vocal only tracks, no background music is used and the user proceeds to the step of recording and auto track merging (shown in FIGS. 7A-7B), as discussed above with respect to recording a bring along instruments. After the user has finished recording they can also auto track-merge and review edits and perform all the other steps as mentioned above with respect to recording a bring along instrument. However, if a user selects the create music option, the external media option, karaoke option and foreign karaoke options, and freestyle option, the user proceeds to the search select preview step (shown in FIGS. 7A-7B), in which the user selects background music, sounds or songs in which they can sing along with. During the search/select/preview step (shown in FIGS. 7A-7B), the user can search a database of songs performed by various artists, and play a sample of a song to assist in song selection. Also, the user can preferably create custom sounds by using the system interface 11 by pressing various touch pads displayed on the touch screen. After the user has selected the particular song they want to perform, or has recorded the background music that they wish to perform over, the next step is the recording and auto-track-merging step (the automation of the traditional and intricate multi-tracking process) as discussed above. When a user has finished recording a track or has finished auto-multi-tracking, and the user still has recording time remaining, the user could create a new recording or the user can redo the previous recording if they do not find their recording satisfactory.

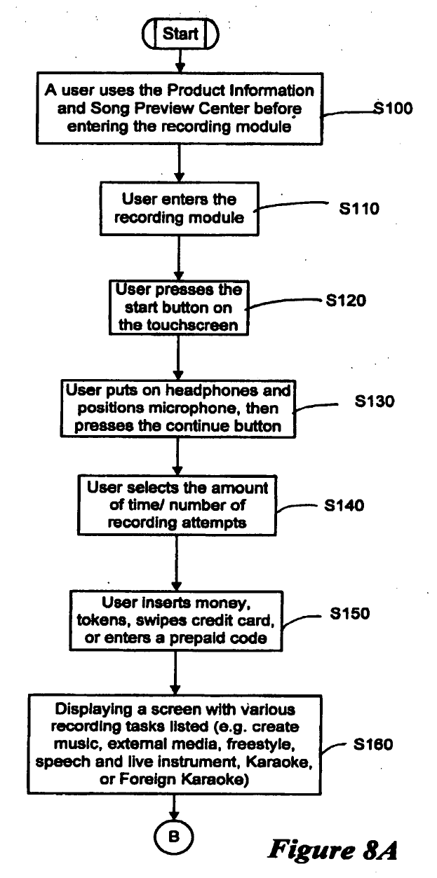

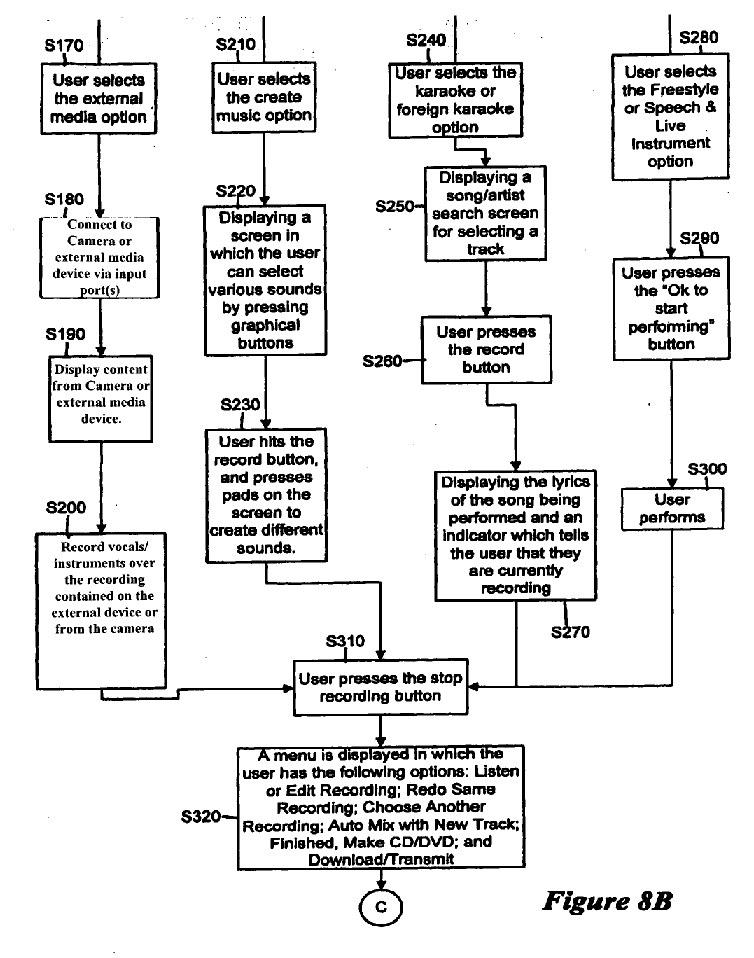

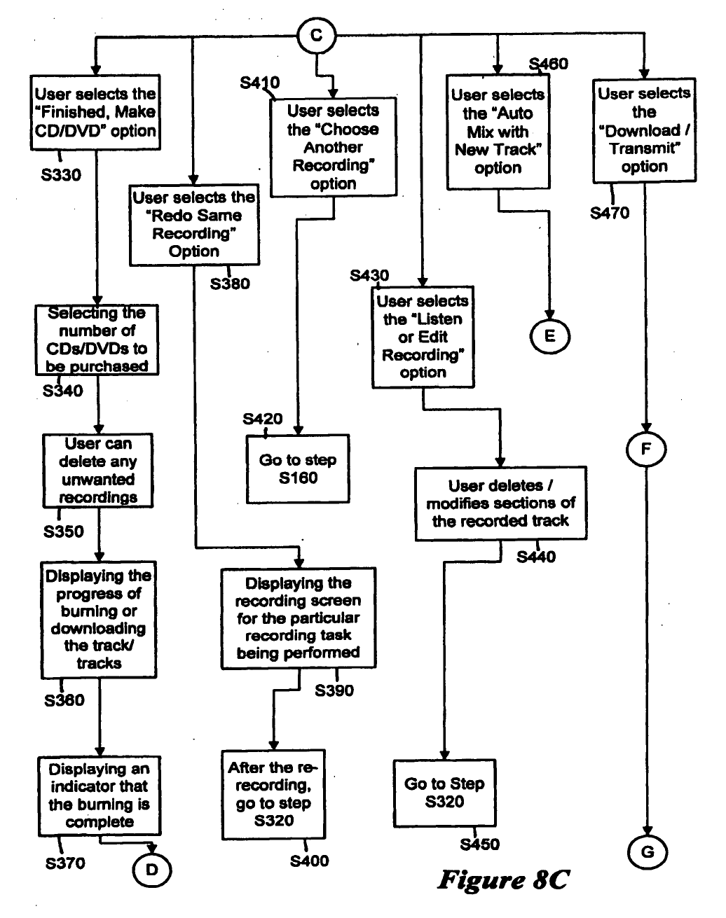

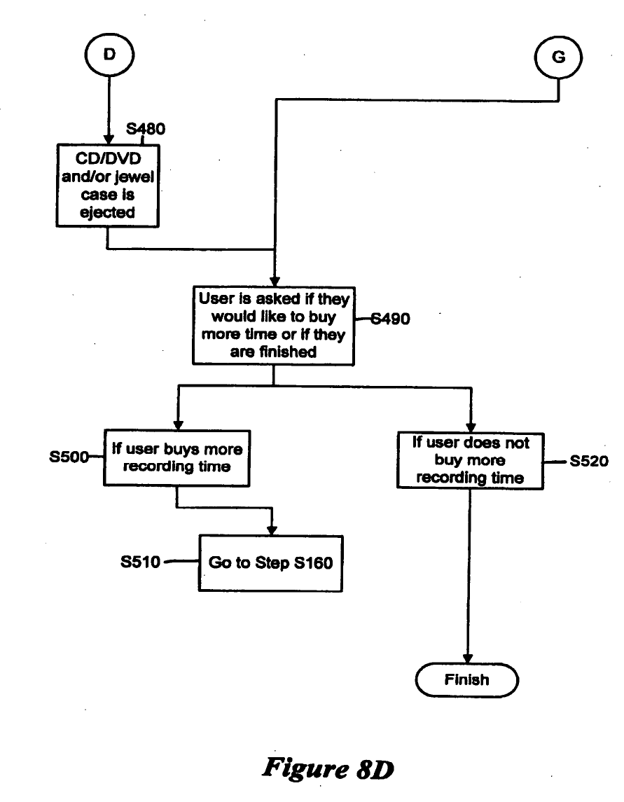

FIG. 8A shows a flowchart of a top-level process where the user is first introduced to and initiates operation of the facility 1. The process begins in step S100 where the user interacts with the product information and song preview center 9 prior to entering the facility 1. In step S100, the user can use the external touch screen of the product information and song preview center 9 to preview different types of music and to preview the recording facility's 1 capabilities. The information and song preview center 9 can alternately be connected to headphones, which allows a user to listen to clips of songs so that they can make a song selection before entering the recording module. In a preferred embodiment of the present invention, in addition to a user mentally making a song selection and previewing songs, a user can use the song preview center 9 in order to make preliminary recording selections which can be accessed by the system interface 11 located within the recording module. That is, information that is selected and stored via the song preview center 9 outside the booth 1 can then be accessed by the system interface 11 located inside the booth 1. Thus, time can be saved by reducing the song selection process and the amount of preliminary steps that are taken before recording inside the booth. Also, by reducing the amount of time a user spends inside the booth, more people are able to use the booth within a given period of time.

The song preview center 9 may also provide waiting customers with instructional information that can be used to inform the user how to operate the system once they are inside the recording module. The process then proceeds to step S110, where the user enters the recording module. In step S120, the user presses a start button displayed on the touch screen of the system interface 11. Upon touching the start button, the computer 43 of FIG. 5 recognizes that the user has initiated a session in the facility 1, and therefore begins a process of interfacing with the user and controlling the auxiliary features previously described in FIG. 5.

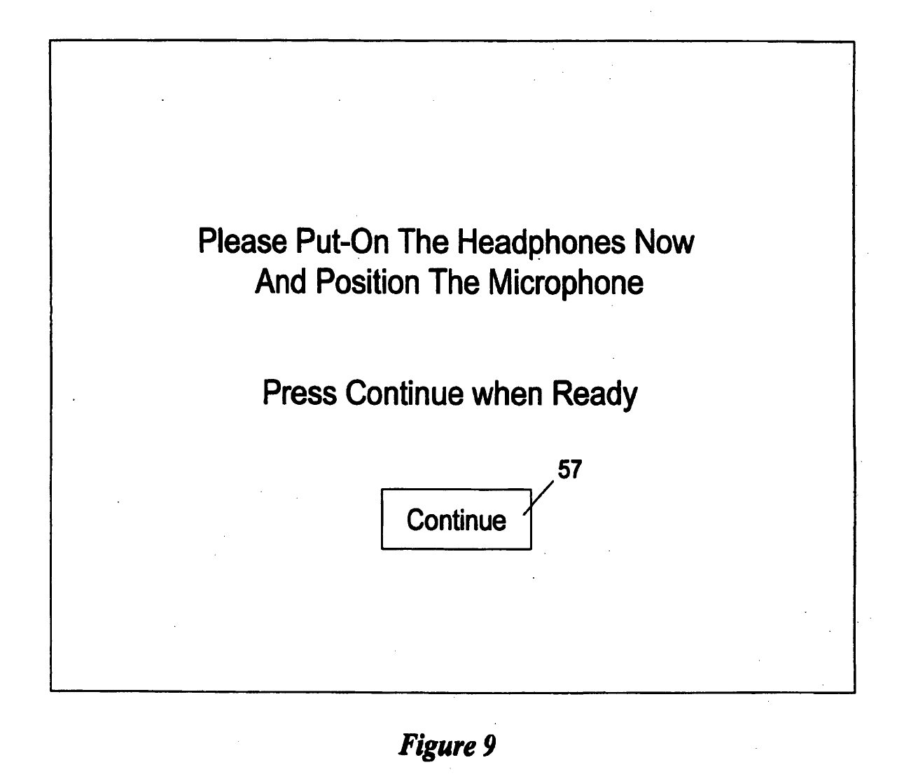

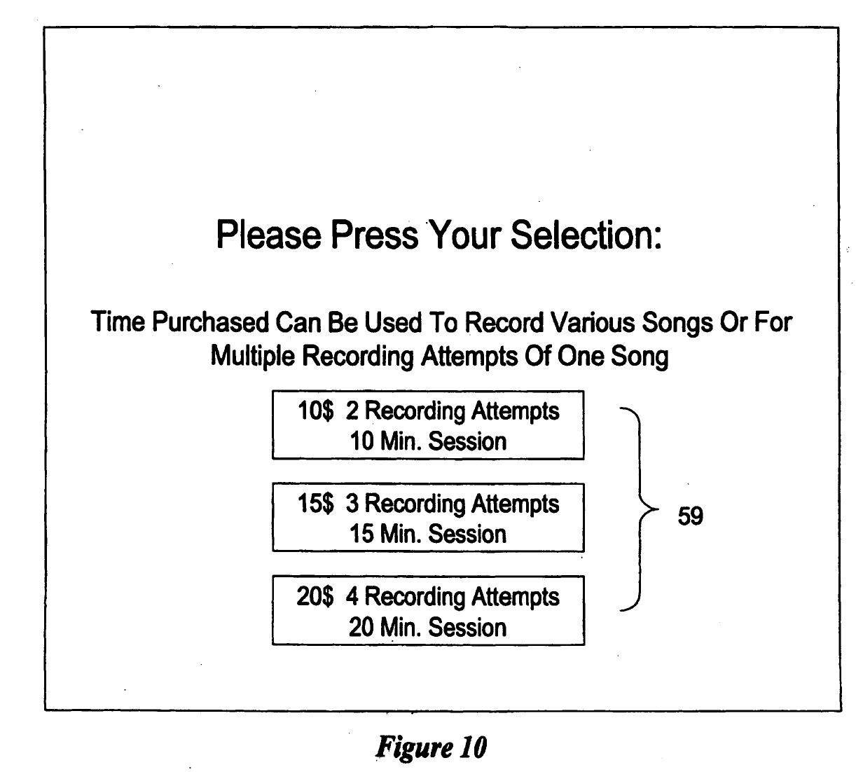

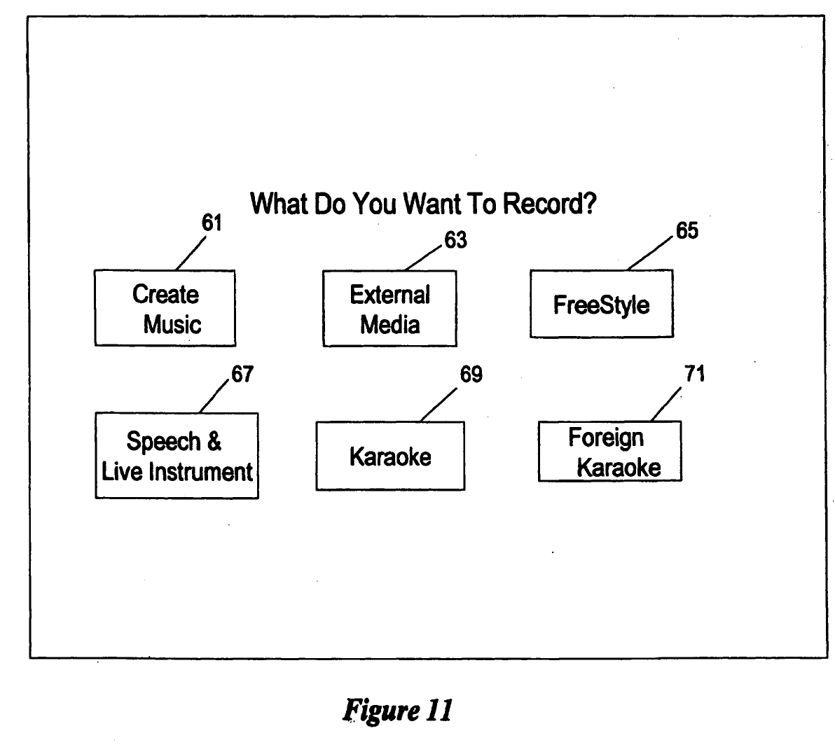

The process then proceeds to step S130 where the screen shown in FIG. 9 is displayed. The user preferably puts on headphones 17, positions the microphone 19 to a comfortable level, and then presses a continue button 57 on the touch screen. In reply, the touch screen, as shown in FIG. 10, presents the user with an amount of time or a number of recording attempts that the user would like to use in step S140. Moreover, the user selects the amount of time when prompted by the touch screen 6, selecting one of recording time buttons 59. The process then proceeds to step S150 where payment for the session can be made in the ways describe above. Once the facility 1 recognizes that the payment has been made and authorized, the process continues to step S160 where the user is presented a display, shown in FIG. 11, with various recording tasks that are presented as options. These options preferably include, but are not limited to, creating a music file, using external media, free style, speech, live instrument, karaoke, or foreign karaoke. This high level process then proceeds to a separate process that will be subsequently described herein, based upon which of the various recording tasks the user selects.

After step S160 the process continues to a user's choice of either steps S170, S210, S240, or S280. The user then selects which of the various recording tasks they want to perform. The recording task the user selects determines the path and processes that the system performs as shown in FIG. 8B. In step S170, a user selects the external media option, in which the user has brought along an external media device such as an MP3 player or iPod® containing a recording the user wants to use while producing a new recording with the automated recording facility 1. In step S180, the user may connect to either the facility's video camera or their external media device to the external device inputs 25 located on the component shell 5 located within the facility 1.

Next, in step S190 the system interface 11 displays the contents from the video camera or of the external device to the user or the content of a directory reserved for files that were transferred into the system via the internet/digital/wireless/network etc. The user can then use the system interface 11, e.g., touch screen, to select which file stored on the external device (or on the reserved directory for files that were transferred into the system by other means) they wish to use in creating their recording while using the automated recording facility 1. At step S200, once the user has selected the file they wish to use, the user records vocals or instruments over the recording contained on the external device or from the contents of the video camera. This option allows the user great flexibility, in that the user can bring in material which may not be available on the database 41, the server 47, or other storage devices accessed by the facility 1. At step 310, once the user has finished recording over the recording from the external device, the user presses a stop recording button on the system interface 11. By pressing the stop recording button, the user ends the recording process. In step S320, a menu is displayed in which the user has several options to manipulate the recording just created. The menu preferably lists, for example, an option to listen to or edit the recording, an option to redo the same recording, an option to choose another recording, an option to mix with a new track, an option to make a CD or DVD, and an option to download or transmit the recording.

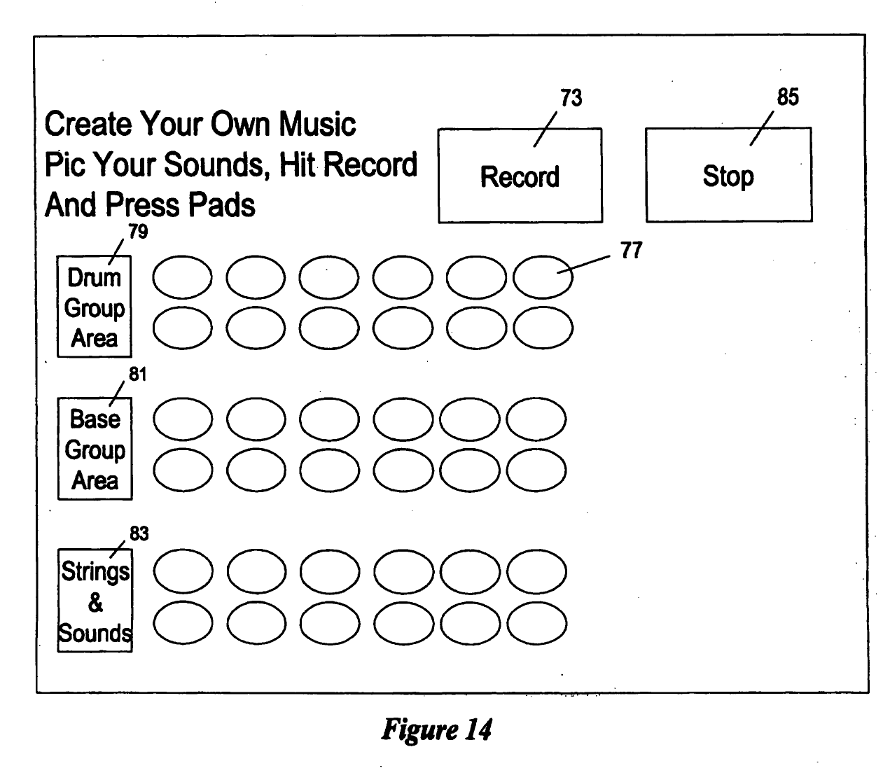

Turning back now to step S160, if in step S210 the create music option is selected, a screen is displayed in step S220 which enables a user to create various sounds by pressing graphical buttons displayed on the screen. The screen that is displayed could look like the screen shown in FIG. 14. FIG. 14 shows a screenshot of a graphical user interface displayed on system interface 11, in which the user can select various sounds and create custom sounds electronically by pressing touch press pads 77. Also shown in FIG. 14 is a drum group area 79. The drum group area 79 preferably includes a drop-down menu including a list of various drum sounds that a user can select. Once the user selects a particular drum sound from the drop-down list displayed in the drum group area 79, the user then pushes the press pads 79 displayed to the right of the drum group area 79 and is able to hear different beats depending on the press pad 77 they press. Accordingly, the user can create several drum sounds without bringing a drum set into the recording facility 1.

Also shown in FIG. 14 is a bass group area 81. The bass group area 81 is similar to the drum group area 79 except that the drum group area 81 includes a drop-down list including the names of different bass sounds. Similarly, the strings and sounds area 83 includes a drop-down list including the names of different string instruments and string sounds. Once the user is ready to create their own music they push a record button 73 and then touch the press pads 77 on the touch screen to create the desired beats, notes and/or sounds for their recording. When the user is finished recording with the create music option the user presses a stop recording button 85 as shown in FIG. 14 and as described in step S310.

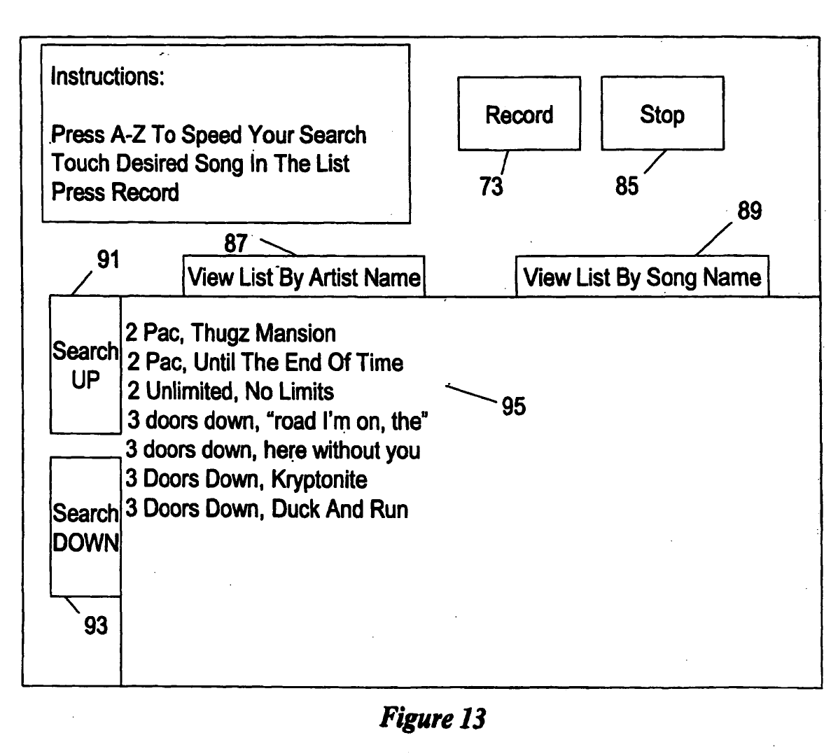

Next, the karaoke and foreign karaoke options will be described. In step S160 a screen as shown in FIG. 11 is displayed. When the karaoke button 69 or foreign karaoke button 71 is selected, as in step S240, a screen is displayed in which the user can search for a song or an artist. In step S250, a screen is displayed as in FIG. 13. In FIG. 13, a particular track preferably can be searched by either the artist's name or the song name. It is envisioned that songs could be searched in other ways (e.g., album name). If the user wants to search for a song based upon the artist's name, the user simply presses the view by artist button 87 and the track list area 95 will arrange the tracks alphabetically by the artist's name. Alternatively, if the user wishes to view the track list area 95 in the order of the songs listed alphabetically, the user presses the view by song button 91. Once the view by song button 91 is pressed, the track list area 95 automatically lists the tracks in alphabetical order based on the song name, irrespective of the artist's name. This feature allows a user great flexibility because they can search for a song if they know the song's name, but do not know the artist's name. Also, they can search for a song if they know the artist's name but they do not know the name of the song. Once the tracks are listed in the order desired by the user, the user can select a track by pressing either the search up button 91 or the search down button 93. The currently selected song appears highlighted on the screen. When the search down button 93 is pressed once, the highlighted track will move to the track below the previously highlighted track. Accordingly, when the search up button 91 is pressed, the highlighted track will become the track above the previously highlighted track. Once the user has highlighted the desired track that they would like to perform with, the user presses the record button 73 and starts to sing along with the song that they selected. If at any point the user wants to stop the recording, they simply press the stop recording button 85.

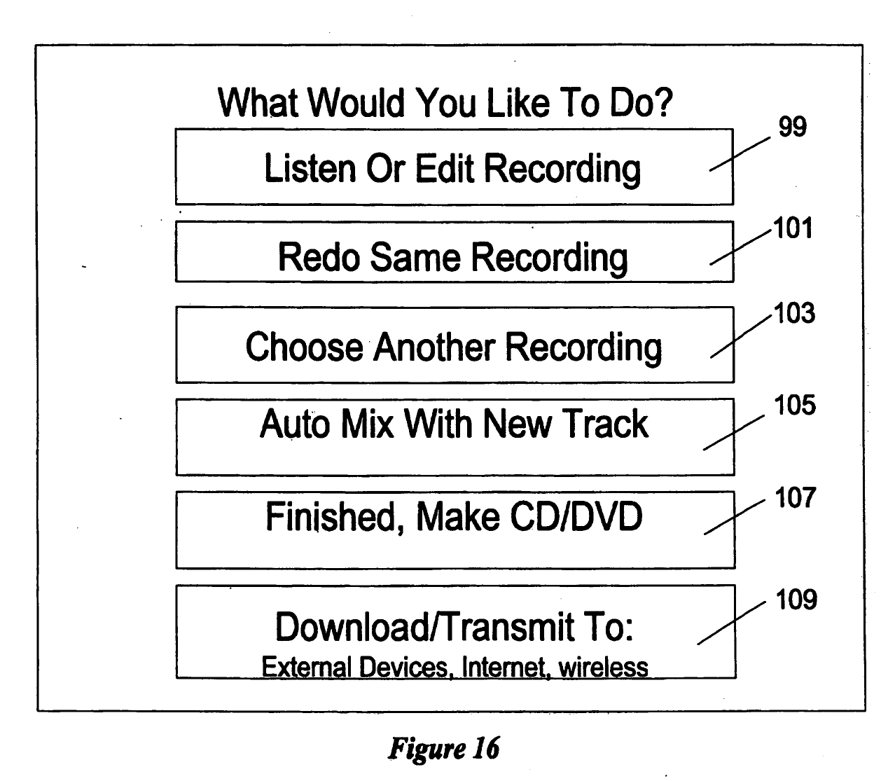

Once the user presses the record button 73 as in step S260, the process progresses to step S270 in which lyrics of the song the user selected are displayed. The lyrics are displayed on the system interface 11. Preferably, when the lyrics are displayed, several words are displayed at the same time, and when the proper time arises for the user to sing a particular word, the color of the word changes. This feature allows the singer to sing the lyrics at the proper pace and rhythm. Once the user has completed their karaoke performance, the user presses the stop recording button 85, as shown in step S310. Once the stop recording button 85 is pressed, the screen as shown in FIG. 16 is displayed on system interface 11, and the process proceeds to step S320.

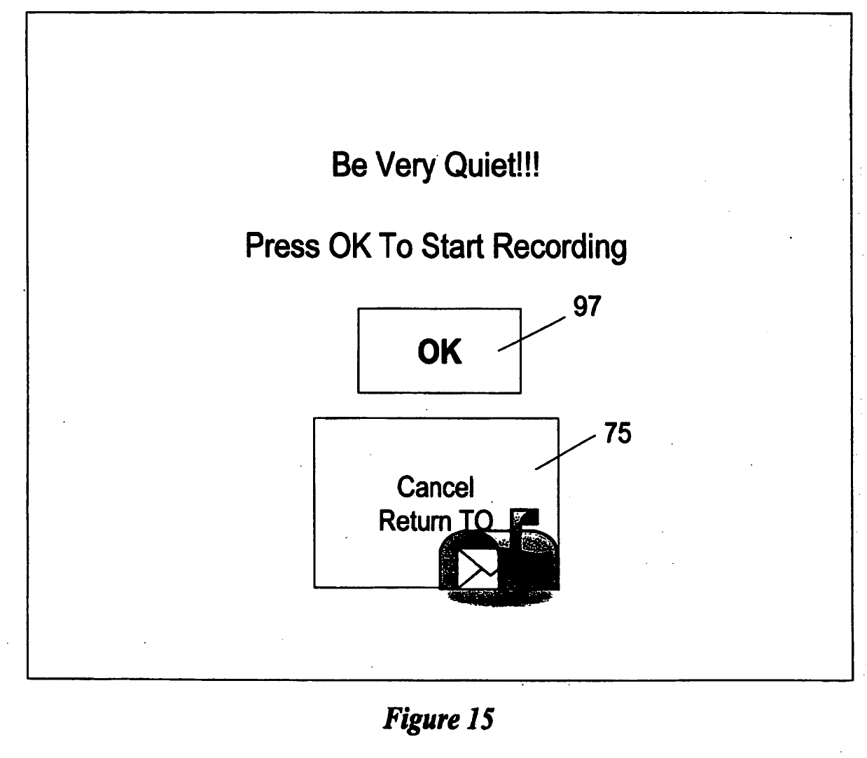

In step S160, when the speech and live instrument button 67 is selected, as shown in FIG. 11, the process proceeds to step S280. In step S280, a screen is displayed on the system interface 11, as shown in FIG. 15. FIG. 15 shows a screen with two buttons displayed on the screen. The first button that is displayed in FIG. 15 is an okay to record button 97. Once a user presses the okay to record button 97, the recording begins and the user starts his or her performance. Because the user is performing a speech, performing a cappella, or performing with an instrument, there is no menu to select custom sounds, and no lyrics are displayed on the system interface 11. The only thing that is displayed on the system interface 11 is an indicator telling the user that they are currently recording. The second button that is displayed in FIG. 15 is a cancel/main menu button 75. When a user presses the cancel/main menu button 75, the system interface 11 displays the screen as shown in FIG. 11 and described in step S160. After the user has pressed the okay to record button 97 in step S290, the user performs their instrumental performance, a cappella performance, speech, etc. in step S300. After the user is done performing, they press the stop recording button 85 in step S310. After the stop recording button 85 is pressed in step S310, a screen as shown in FIG. 16 is displayed.

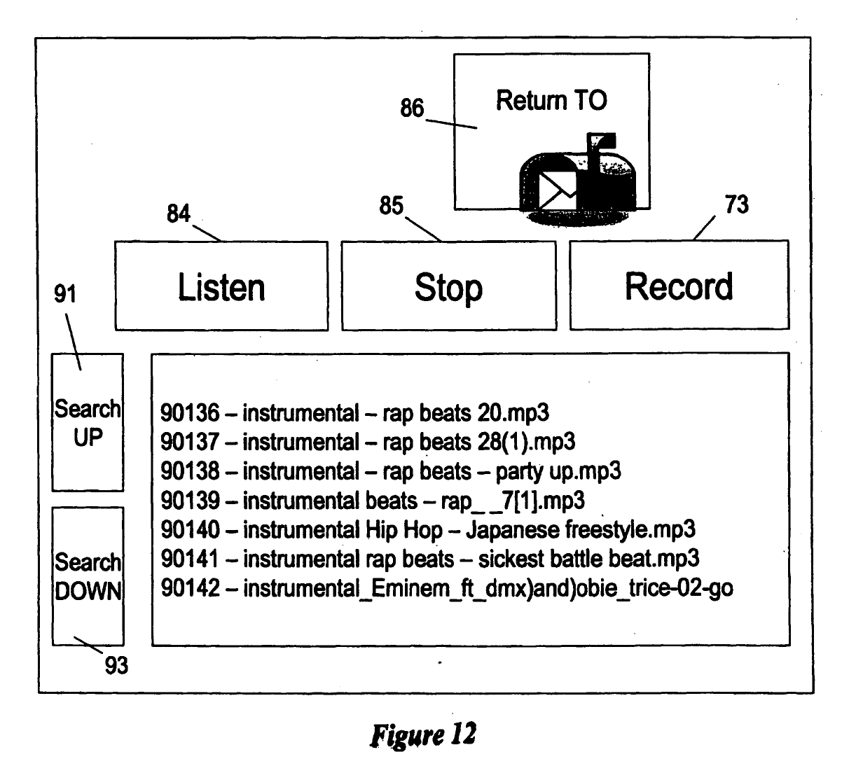

In step S160, when the freestyle button 65 is selected, as shown in FIG. 11, the process proceeds to step S280. In step S280, a screen is displayed on the system interface 11, as shown in FIG. 12. FIG. 12 shows a screen displaying background rhythm tracks, also known as “beats,” that a user can select and use during their recording. The screen shown in FIG. 12 is operated in a similar manner as the screen shown in FIG. 13. A search up button 91 and a search down button 93 are used to select which beat the user wants to preview or record their performance with. Once the user has selected a beat or background music, a listen button 84 can be selected in order to preview the beat. Once the user has selected the beat they wish to record with, the record button 73 is selected and the user begins recording. Once the recording is finished, in step S310, the stop button 85 is pressed. Once the stop recording button 85 is pressed, the screen as shown in FIG. 16 as displayed on system interface 11, and the process proceeds to step S320. Also shown in FIG. 12 is a main menu button 86. When the main menu button 86 is selected the screen as shown in FIG. 11 is displayed.

In step S320, a menu is displayed in which the user has preferably at least six options. However, other options to display are possible. The preferred options that are displayed on the screen are: listen or edit recording; redo same recording; choose another recording; auto-mix with new track; make CD/DVD; and download/transmit to: external devices, Internet, wireless. The user can select one of the six options by pressing one of the appropriate buttons on the system interface 11. The first button that is displayed is a listen or edit recording button 99. Displayed underneath the listen or edit recording button 99 is a redo same recording button 101. Located beneath the redo same recording button 101 is a “choose another recording” button 103. Next, located underneath the “choose another recording” button 103 is an “auto-mix” button 105. Underneath the “auto-mix” button 105 is a “make CD/DVD” button 107. Lastly, a “download/transmit” button 109 is displayed underneath the make CD/DVD button 107. When one of the six buttons displayed in FIG. 16 is selected, the user is able to perform the function listed on the button. For example, when the user presses the “listen or edit recording” button 99, a menu is displayed in which the user can listen or edit the recording they have just produced.

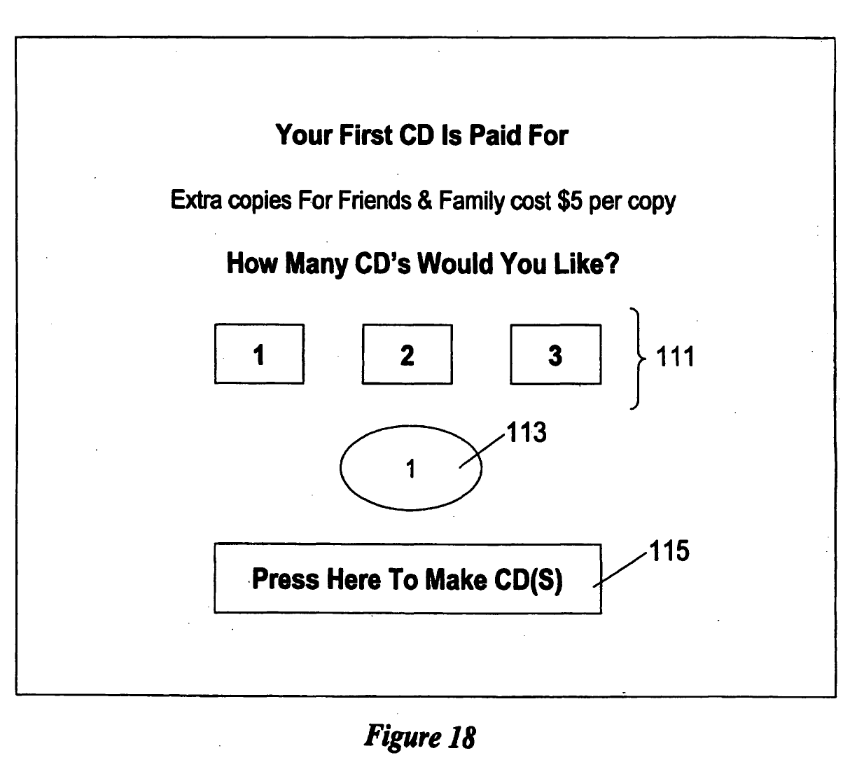

Turning now to FIG. 8C, in step S330, a user has selected the “make CD/DVD” button 107 from the screen displayed in FIG. 16. Once the “make CD/DVD” button 107 is pressed, a screen, preferably as shown in FIG. 18, is displayed. FIG. 18 shows a CD/DVD number selection area 111 in which multiple buttons are displayed that include consecutive numbers listed on each respective button. For example, as shown in FIG. 18, three buttons are displayed with each button containing the number of CDs the user wants produced. Thus, the first button contains the number one, indicating that the user would like one CD or DVD to be produced. The next button shown in the CD/DVD number selection area 111 is a button with the number two indicated thereon. The last button in the CD/DVD number selection area has the number three printed on the button to indicate that the user would like three CDs/DVDs to be produced. Also shown in FIG. 18 is a CD/DVD number display area 113 indicating the number of CDs that the user selected when pressing a button within the CD/DVD number selection area 111. For example, if a user pressed the number two button in the CD/DVD number selection area, the number two will be displayed in the CD/DVD number display area 113. This allows the user to confirm which button in the CD/DVD number selection area 111 they pressed. Once the proper number is displayed in the CD/DVD number display area 113, the user presses a “make CD” button 115 and the computer 43 sends a signal to the CD/DVD producer 37 and the appropriate number of CDs/DVDs are produced.

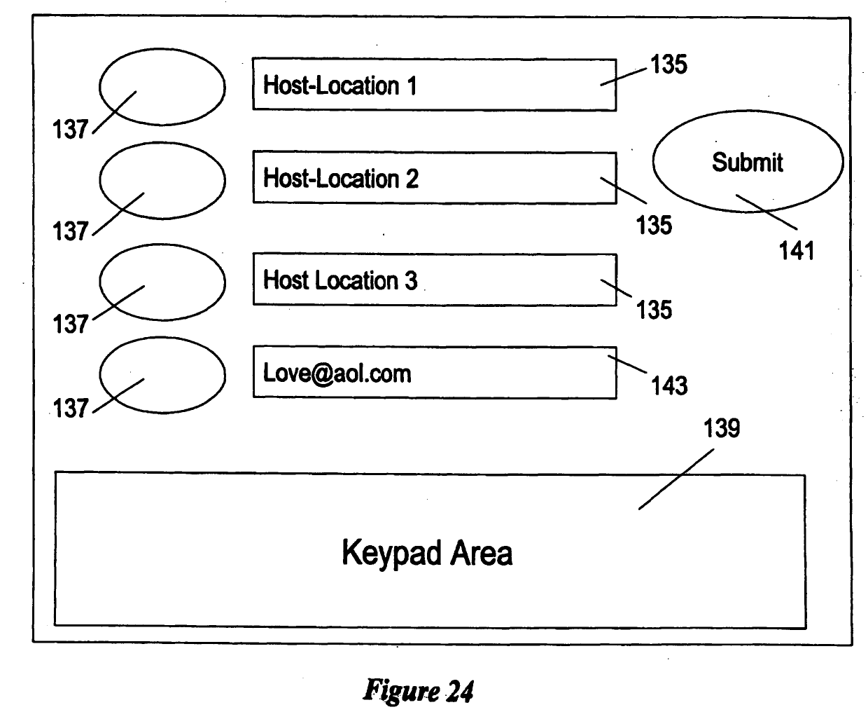

Once the appropriate number of CDs/DVDs to be purchased is selected in step S340, and before the CDs or DVDs are actually produced, a screen, as preferably shown in FIG. 24, is displayed. The screen shown in FIG. 24 allows a user to delete any unwanted recordings before burning these recordings to a CD or DVD. For example, if a user created multiple recordings during one recording session, and only one recording was satisfactory to the user, the user could delete all unwanted recordings and only burn the best recording to the CD. The user would thus only have a copy of the finished and desired recording. Prior to a user manipulating the screen as shown in FIG. 24, a user selects from a list of recordings displayed on a screen. Once a user selects a particular recording, the screen, as preferably shown in FIG. 24, appears. With the selected recording, the user has three options as shown in FIG. 24. The user selects an option by pressing one of three buttons: a play button 117, a stop button 119, and a delete button 121. When the user presses the play button 117, a sampling of the recording, or alternately the entire recording, is played and the user can determine if they want to keep this recording or if they would like to delete this recording prior to burning a CD or DVD. The stop button 119 will stop the sampled recording after the user has pressed the play button 117. The delete button 121 will delete the selected recording. Once the user has disposed of the selected recording in the manner desired, the user can press the continue button 123 and go back to the previous screen, which is not shown in the figures, and select another recording that was produced during the particular recording session and either keep that recording or delete that recording. Once the user has deleted or kept the recordings they wish, the user can press a return to main menu button 125 and the screen, preferably shown in FIG. 16, is displayed.

Once the user has deleted any unwanted recordings as described above, the process continues to step S360. In step S360, a screen is displayed that indicates the progress of burning a CD or DVD, or the progress of downloading a recording or recordings to a destination, e.g. an Internet website, an email account, etc. In step S370, a screen is displayed that indicates that the burning or downloading of the recording is complete. In step S480, the CD/DVD dispenser 29 outputs the produced CD or DVD. Also during step S480, if a CD or DVD jewel case has been purchased, the jewel case dispenser 31 ejects the jewel case at this point. Next, in step S490, a screen appears in which the user is prompted if they would like to buy more recording time or if they are finished with their recording session. In step S500, if the user wants to buy more recording time, the process proceeds to step S510. In step S510, the next screen that is displayed on the system interface 11 is the screen displayed in step S160, namely FIG. 11. In step S520, if the user does not want to buy more recording time, the recording process is over and the user may exit the automated recording facility 1.

Turning now to FIG. 8C, if a user selects the “redo same recording” button 101 as preferably shown in FIG. 16 and as described in step S380, a screen is displayed in which the user can record the particular recording task they were previously performing. That is, in step S390, if the user was previously creating a recording with an instrument brought by the user, and the user wanted to redo this recording, the screen displayed is preferably the same screen displayed when a user is recording with an instrument. Another example is if a user would like to redo a karaoke performance, the screen, as preferably shown in FIG. 13, would be displayed in step S390. In step S400 after the user has re-recorded the performance, the screen in FIG. 16 is preferably displayed, and the process jumps to step S320.

In step S320, if the user selects the “choose another recording” button 103, displayed in FIG. 16, as in step S410, the process proceeds to step S420. In step S420, the screen, preferably shown in FIG. 11, is displayed. That is, the user has the option of creating a different type of recording (e.g., create music, external media, freestyle, speech and live instrument, karaoke, and foreign karaoke).

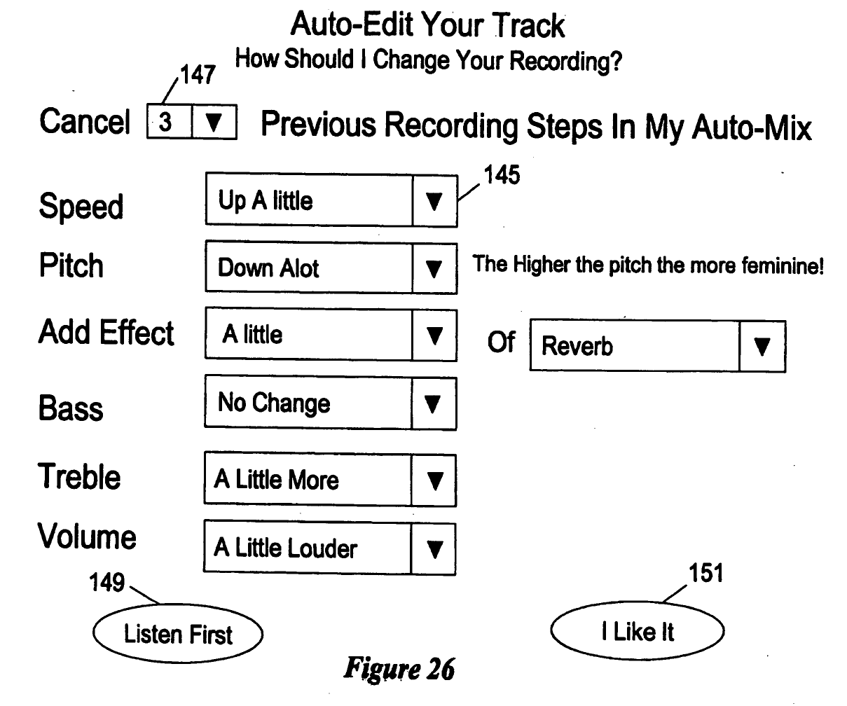

In step S430, if the user selects the “listen or edit recording” button 99, as preferably displayed in FIG. 16, the user is given the ability to listen to their previously recorded track and to edit their recording. However the system presents a simplified edit-screen suitable for the average user. In step S440, a user is able to edit their recording by navigating a screen as preferably shown in FIG. 26, displayed on the system interface 11. Examples of editing features that can be performed are erasing sections of a track, adjusting the vocal pitch correlation of a track, adjusting the bass in a track, the treble, or the midrange.

Using the auto-edit screen, preferably shown in FIG. 26, users may alter their previously recorded tracks. The auto-edit screen controls various editing features that utilize digital algorithms in order to edit or modify a recording. The auto-edit screen uses simple settings and commands such as “change a little” and “speed up a lot,” as opposed to using complex ratios and percentages that are usually associated with utilizing such features. Various preferred editing parameters such as speed, pitch, reverberation, bass, treble, volume, etc. are adjusted by means of a drop-down menu 145. Other editing parameters are possible. Alternately, it is envisioned that these parameters could be adjusted in other ways besides drop-down menus.

In addition, the auto-edit screen, as preferably shown in FIG. 26, allows users to revert back to a previous recording and to cancel multiple recorded layers in a merged composition. A user can also revert back to a previous recording by selecting the number of recording steps they want to cancel by using a recording cancellation menu 147. The recording cancellation menu 147 contains a drop-down menu listing consecutive numbers, indicating the amount of recording steps the user wants to undo (e.g. revert back to previous recording versions). For example, if a user selects the number two from the recording cancellation menu 147, the last two recording steps will be undone and the user can then edit or multi-track the recording as it was prior to the last two recording steps. The user may preview their changes to the recording before allowing such changes to take place by pressing an edit preview button 149. Once the user is satisfied with the edits they have made, they press an “edit save” button 151.

For every recording attempt, auto-merge, or edit change, the computer 43 preferably saves a copy of the prior track without the applied changes, and saves a copy of the track with the applied changes or recorded additions. As such, the system provides the user with a simple way to cancel changes in his track, edit tracks, redo changes, and create multi-layered recording compositions without having to perform complex recording/editing processes.

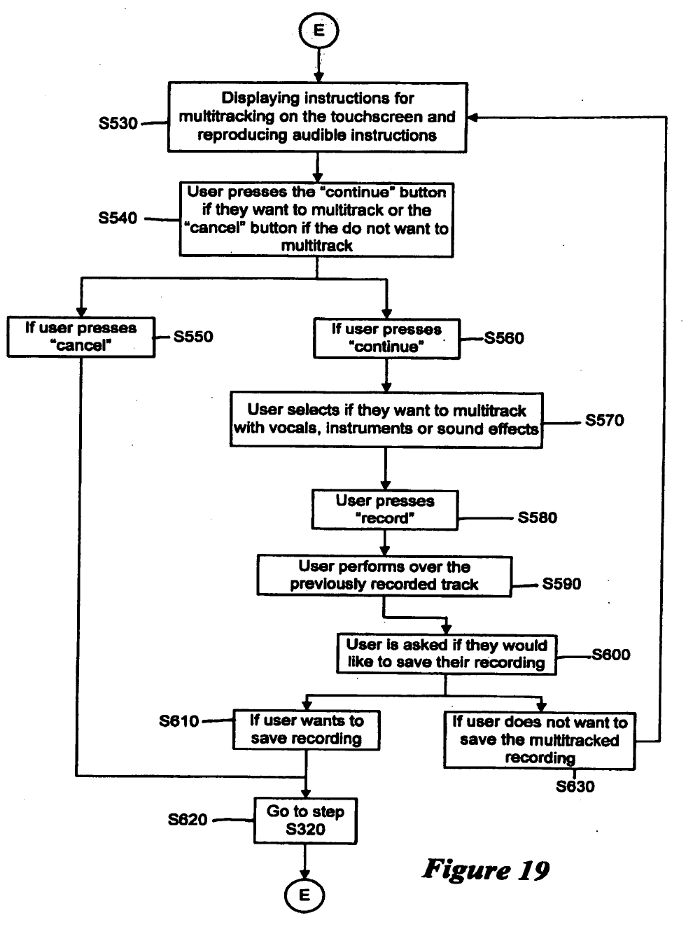

It is also contemplated that other more advanced editing features could be simplified for the average user and carried out by the automated recording facility 1 during the editing process. After the user has finished listening to the recording or editing the recording, the process continues to step S450. In step S450, the screen, preferably shown in FIG. 16, is displayed in accordance with step S320. In step S460, a user selects the “Auto Mix” button 105 that is preferably displayed in FIG. 16, which carries out the automated merged-multi-track functions that automates the multi-tracking process. The multi-tracking process is described in the flowchart in FIG. 19.

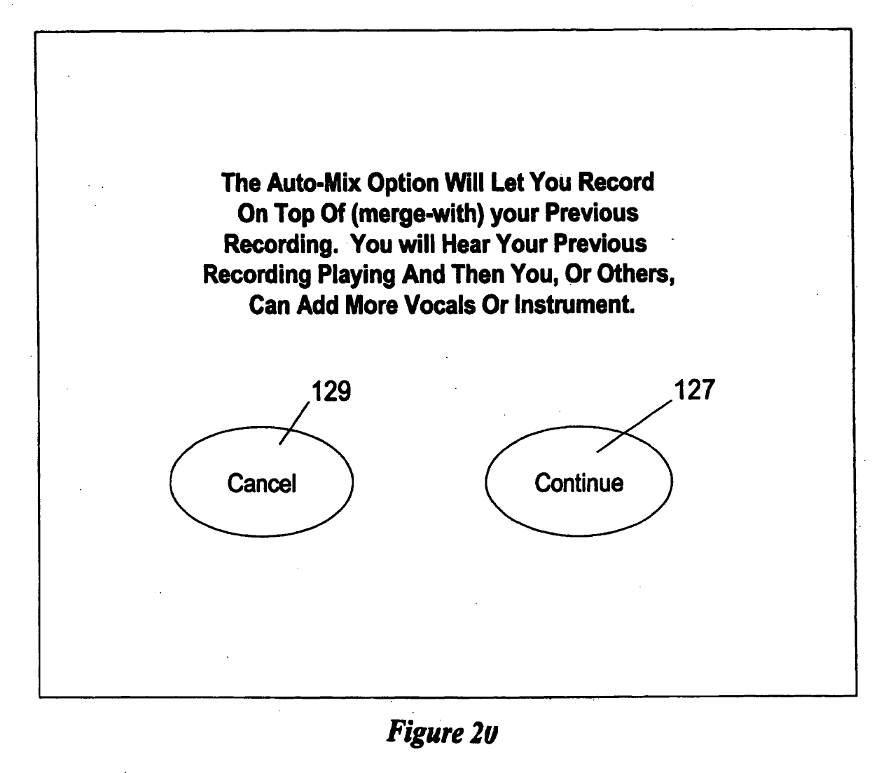

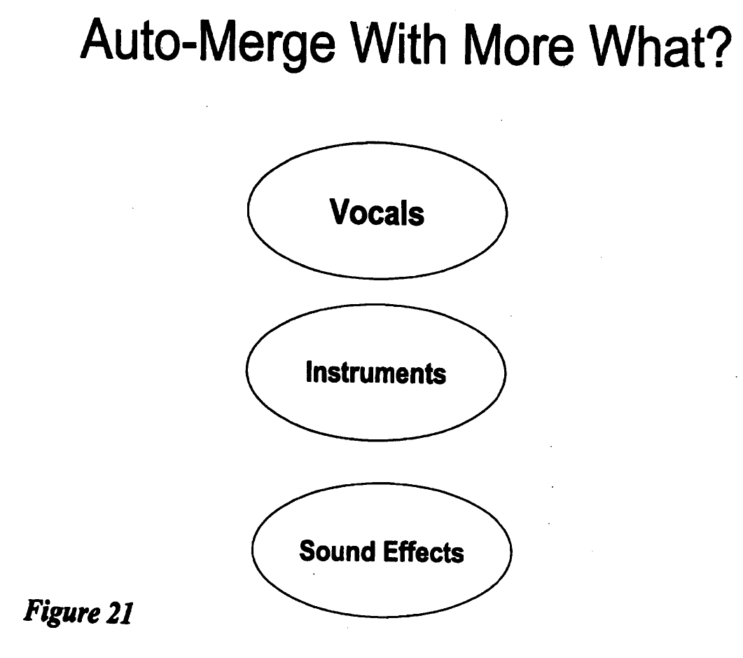

In FIG. 19, in step S530, a screen is displayed (not shown) that provides instructions and information for the auto-multi-track-merge (“auto mix”) option on the system interface 11. Also, in addition to displaying information/instructions, just as in any other step of using the preferred embodiment of the invention described above, audible instructions are preferably heard on the headphones 17 and/or speakers that are located inside the automated recording facility 1. Next in step S540, the screen as preferably shown in FIG. 20 is displayed. The screen shown in FIG. 20 contains two buttons: a CONTINUE button 127 and a CANCEL button 129. When the user is ready to use the auto-multi-rack-merge function, the user presses the CONTINUE button 127 on the system interface 11, as in step S560. Next, in step S570, the screen in FIG. 21 is displayed in which the user can select the type of media with which they want to auto-merge their previous recording. For example, in FIG. 21 three preferred options are presented to the user (such as, but not limited to, vocals, instruments, and sound effects). Once the user selects one of the three options, the system interface 11 displays a recording screen (see FIGS. 14 and 15) for the chosen type of recording as described above.

Next, in step S580, the user presses the appropriate record button and the user will hear the previous recording playing in the background while the user adds new vocals or instruments or any other type of music on top of the previous recording. “Multi-tracking” is a professional studio term that describes a method of producing a song which is composed of various different layers, or tracks, of music. Typically, in order to perform a multi-tracking process, a studio engineer or an individual with prior knowledge of a multi-tracking process needs to be present in order to record and then mix/merge separately recorded tracks into one track with the use of a soundboard and/or other intricate recording-studio software tools. However, with the present invention, the computer 43 (using the system's custom software) automatically performs the multi-tracking process via the auto-multi-track-merge function and a user with ordinary knowledge can simply trigger this function by pressing a button on the touch screen and can emulate the result of a complex multi-tracking process, namely the creation of a multi-layered composition.

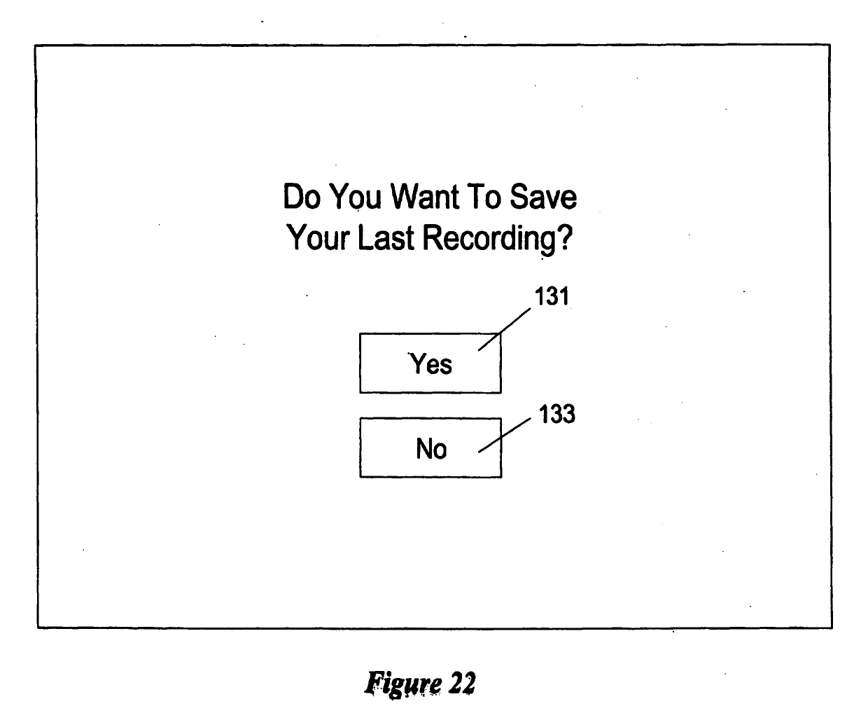

In step S590, the user performs over their previously recorded track. Next in step S600, and as shown in FIG. 22, a screen is displayed in which a user is asked if they would like to save their recording. In step S610, if the user wants to save the recording, they press a YES button 131 and the process continues to step S620. In step S620, the process continues to step S320 and the screen in FIG. 16 is preferably displayed. However, if the user does not want to save their multi-tracked recording, in step S630, the user presses a NO button 133 and the process proceeds to step S530. That is, in step S530, a screen is displayed again providing instructions for multi-tracking on the touch screen and audible instructions are again reproduced for the user. Accordingly, the user can then redo their multi-tracked recording working off the original (or previously saved) recording.

At the conclusion of each automated recording process the user is preferably back to the same screen that triggered the process and, again, can choose to listen, auto-edit the recording, trigger this process again, or begin a new composition. As previously described, with each request for a new recording, the system displays a screen that asks the user whether to keep the last recording or not. In a multi-merged composition, the last recording is the last recorded addition made by the user. The recording facility 1 keeps a copy of all recording attempts. Thus, eliminating the most recently merged-recording addition or additions is easily performed by selecting the YES button 131 or the NO button 133 shown in FIG. 22. In the event that the user desires to eliminate multiple merged-recording-additions, as opposed to just the last recording, the auto-edit screen as shown in FIG. 26 and described above becomes helpful in providing the user with such functionality.

Turning now to step S540 and FIG. 20, if the user does not want to proceed with the multi-tracking function, the user presses the CANCEL button 129 as shown in FIG. 20 and the process proceeds to step S620. That is, in step S620, the process reverts to step S320 and the screen as preferably shown in FIG. 16 is displayed. From this screen, the user then has the option of listening to or editing their recording, redoing their recording, choosing another recording, multi-tracking again with a new track, making a CD or DVD, or downloading and transmitting their recording to the Internet or an external device, etc.

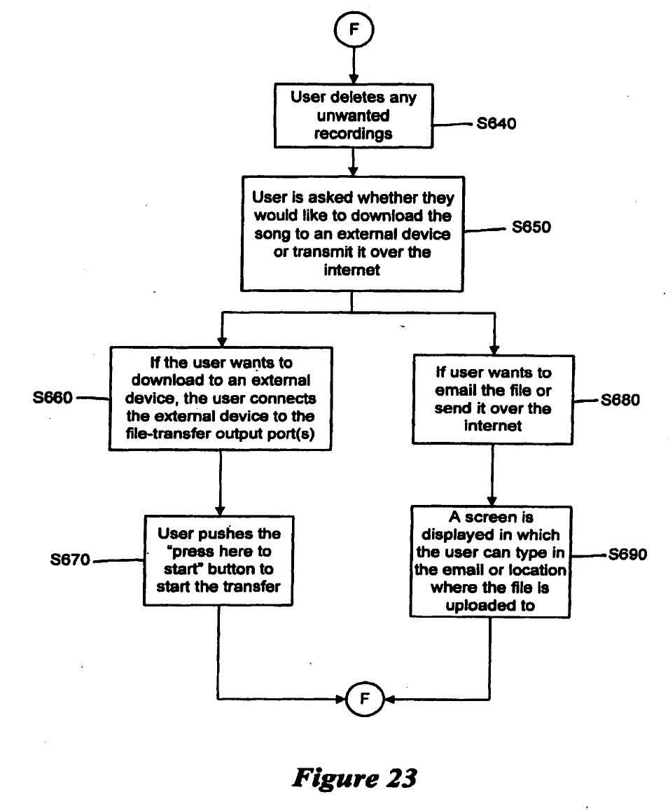

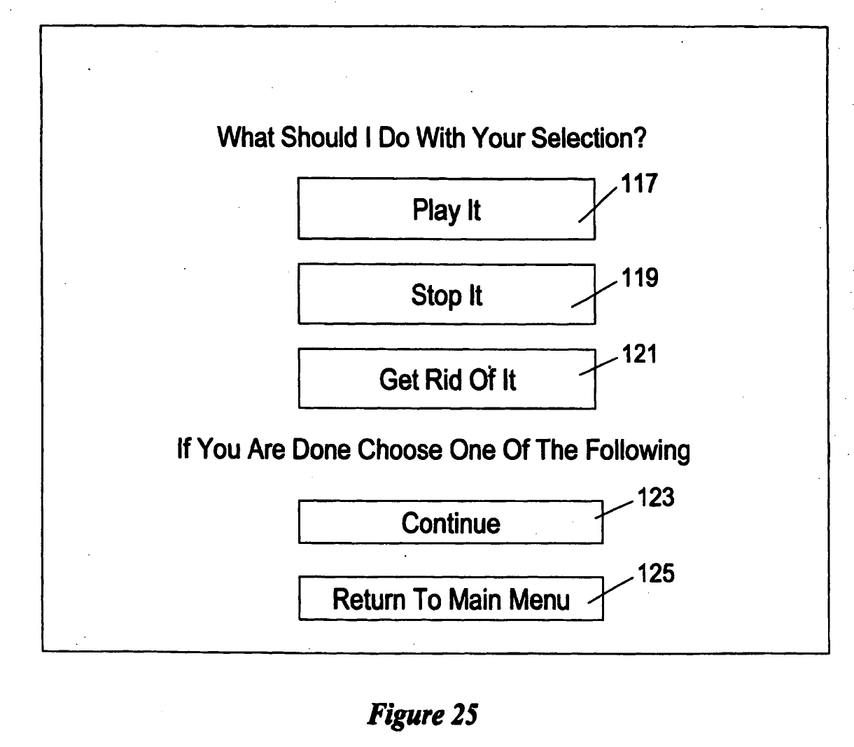

Turning now to FIG. 23, FIG. 23 shows a flowchart describing the download and transmit option. In FIG. 8C, when a user in step S470, selects the download/transmit button 109 from the screen preferably displayed in FIG. 16, the first screen that is displayed is the screen shown in FIG. 25. The user can manipulate this screen as described above. Thus, in step S640, the user can delete any unwanted recordings before transmitting or downloading their recordings over the Internet or to an external device. In step S650, a screen is displayed that asks a user if they would like to download their recording to an external device or transmit it over the Internet. In step S660, if the user wants to download the recording to an external device such as an MP3 player, the user connects their external device to the external device inputs 25 and then in step S670 a screen is preferably displayed that prompts the user to push a button in order to start the transfer of the recording from the automated recording facility 1 to the user's external media device.

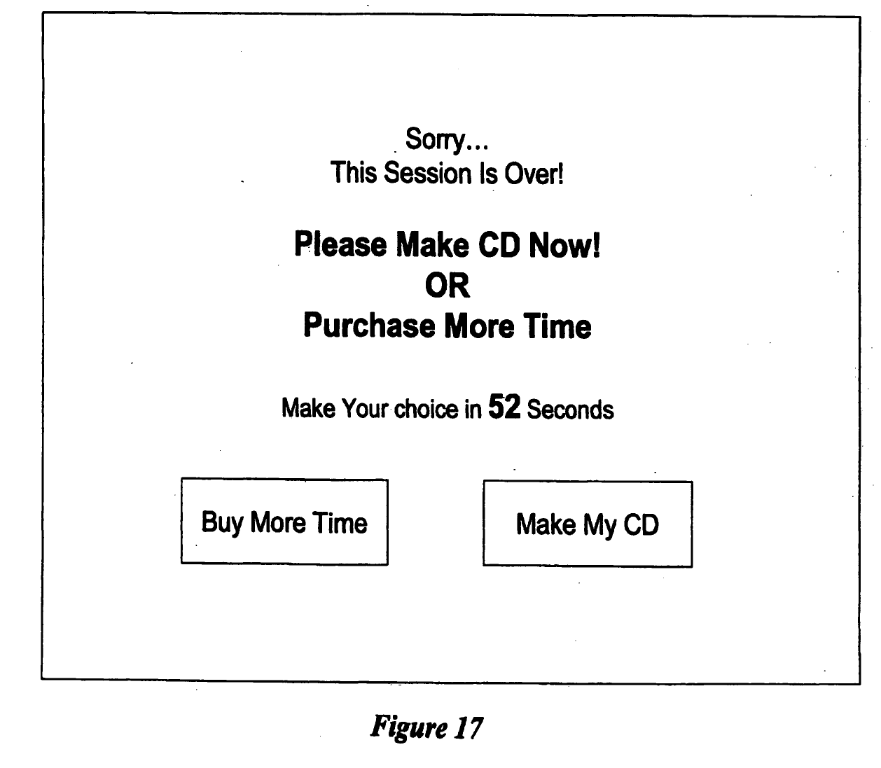

However, if, as in step S680, the user wants to e-mail the file or otherwise send it over the Internet, a screen is displayed as preferably shown in FIG. 24. Thus, in step S690, the screen as shown in FIG. 24 is displayed. In FIG. 24, four destination location boxes 135 are preferably shown, each containing a different location to which a user's recording can be transmitted. For example, these destination location boxes can include the location of a server or could include an e-mail address. A user can insert an e-mail address to which they would like to transmit their recording, by using a keypad area 139 as shown in FIG. 24. The keypad area 139 may include, for example, an alpha-numeric keypad containing both letters, numbers and other common characters that a user can select via a touch screen. A user selects a particular destination by touching one of multiple SELECT buttons 137 located adjacent to the destination location boxes 135. Thus, by selecting the SELECT button next to a particular destination location box, the user selects the destination recited inside the particular destination location box 135. Again, if the user wants to transmit to an e-mail address, the user selects the SELECT button 137 adjacent to the e-mail input field 143 and is then able to use keypad area 139 to type in the desired destination e-mail address. Once the user has selected the appropriate destination with the SELECT button 137, the user presses a SUBMIT button 141 and the recording is transmitted to the selected destination. After step S690, the process proceeds to step S490 as shown in FIG. 8D. In step S490, a screen as in FIG. 17 is displayed asking the user if they would like to buy more recording time or if they are finished recording. If the user desires to buy more recording time as in step S500, the process proceeds to step S510. In step S510, the process jumps to step 160 and the screen as preferably shown in FIG. 11 is displayed. However, if as in step S520, the user does not want to buy more recording time, the recording process is over and the user has finished using the automated recording facility 1. Thus, the user can exit the facility 1 via the main door 33 and allow another individual to use the recording facility 1.

### Computer-Based Implementation

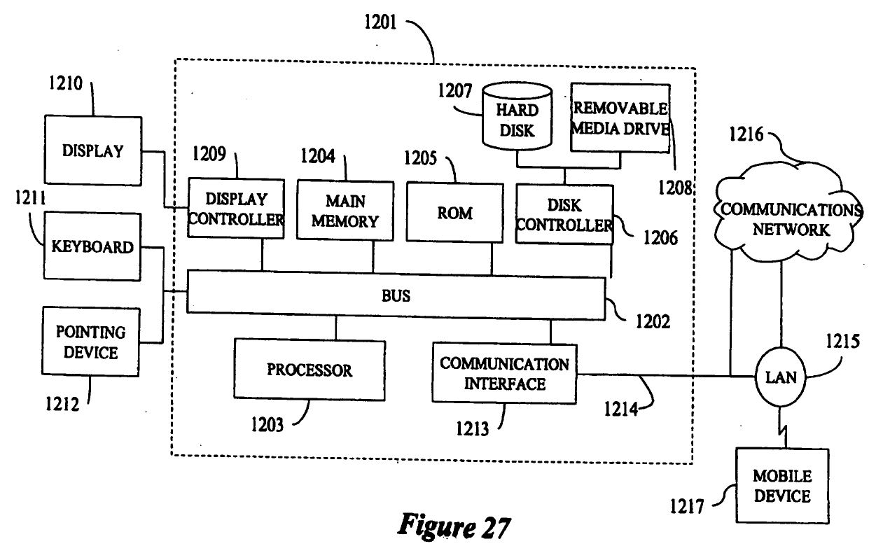

FIG. 27 illustrates a computer system 1201 upon which another embodiment of the present invention may be implemented. The computer system 1201 preferably includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, or removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)). The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read. Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

### Pre-Selection by Users for Faster Processing

According to one feature, the facility 1 (FIG. 1) may allow users to preview and/or select recording options prior to entering the recording chamber. For example, while another user is inside the recording chamber, a second user may browse through music/song options, select a play list, download a previously recorded track, etc. The second user may utilize the product information and/or song preview center 9 located on the exterior of the facility or kiosk 1 to make such selections. In some implementations, a facility may include a plurality of song preview centers 9 to allow multiple users to concurrently review songs and perform pre-selection of recording options. Consequently, the song preview center 9 may reduce the time spent by the user inside the facility 1 by allowing preliminary information to be saved when the user is outside and another user is recording inside the facility 1. This enables more users to use the automated recording facility 1 in a given amount of time.

### Complete Recording Experience in a Self-Contained Vending-Type Kiosk

Thought there have been multiple attempts to deliver a commercially-viable self-contained or self-operated recording and/or production systems, these systems have failed to provide a complete (end-to-end), automated recording experience that emulates common studio functionality and features, production quality, and accommodating multipurpose recording tasks (not limited to karaoke, single a track performance, or single layer recording). By comparison, the present disclosed recording facility describes a vending-type recording kiosk that includes full recording studio capabilities, including multi-track recording without, in an automated and/or unattended manner. For example, the present recording facility can retain or store a plurality of recorded compositions, songs, and/or tracks for a user so that the recording medium is only burned once all merging, mixing, and/or layering is complete and the user has recorded all desired songs or compositions. Additionally, the recording facility uses headphones (instead of speakers) to reduce feedback and provide a user with a true recording experience.

Additionally, the recording facility allows the user to select from a plurality of different features, such as compression, sound effects, and vocal pitch correction, etc., to improve the recorded tracks, songs, and/or compositions that are eventually burned into a recording medium.

### Automated Multi-Track Merging and Mixing Features

Another feature of the recording facility allows users to easily and automatically record and/or merge multi-track audio/video compositions (music, songs, etc.). In the prior art, creating a multi-track composition (where multiple versions of a composition are layered or merged) typically requires assistance of an engineer to operate recording equipment to perform these tasks. However, the removable recording equipment module of the presently disclosed recording facility may have multi-track recording, merging, and/or layering capabilities that allow a user to select such options from a simple menu and performs these tasks in an automated and/or unattended manner, without the assistance of an engineer or third party.

Some examples of various recording, merging, and/or layering operations that may be performed by the removable recording equipment module may include:
(1) recording merged multi-track composition of bring-along musical instruments, where multiple different musical instrument recording tracks may be merged together (e.g., a piano track is merged with a guitar track, etc.);
(2) merging multi-track vocal compositions for vocal harmony, where recordings from different signers (or the same singer) may be merged or layered together into a single composition;
(3) merging or layering a vocal composition with an uploaded previously recorded composition (e.g., vocal composition, multi track composition, vocal or instrumental composition, etc.); and
(4) recording and merging multi-track vocal and/or instrumental composition with a favorite karaoke tune to create rich harmony.

Consequently, the recording equipment provides the ability to multi-track and/or merge vocal and/or instrumental compositions of the same or different users recording at separate times and/or locations to create original musical compositions by using a touchscreen user interface and built-in software to arrange sounds and without the assistance of a third party or sound engineer.

One key in merging and/or layering multi-tracks is the ability of synchronizing one track to another. In one example, this may be accomplished by a continuous loop technique where a previous track is played to the user (e.g., via earphones) while the user sings the next track, thereby allowing the user to align and/or layer one track on top of one or more previous tracks.

### Example Vending-Type Recording Studio Kiosk

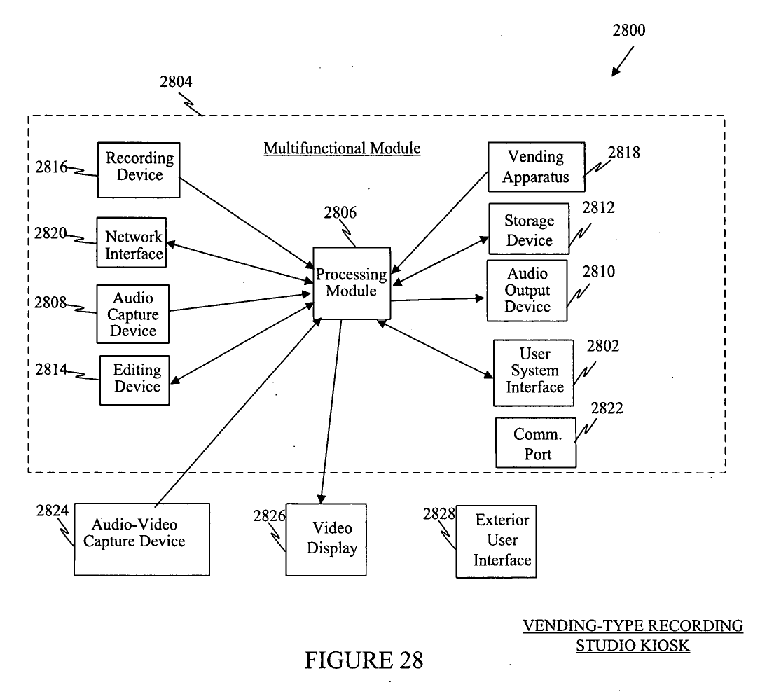

FIG. 28 is a block diagram illustrating an example of a vending-type recording studio kiosk. The vending-type recording studio kiosk 2800 may include an external shell, a user system interface 2802, and/or a multifunctional module 2804. The external shell may have sound-dampening material and define an interior recording chamber. The user system interface 2802 may provide instructions to users and/or receive user selections. The user system interface 2802 may be integrated as part of the multifunctional module 2804 and may provide multilingual support for instructions and/or selections in audio and visual forms. The multifunctional module 2804 may be located within the recording chamber and controlled via the user system interface 2802. The multifunctional module 2804 may be removable and interchangeable with another multifunctional module. The user system interface and multifunction module may be adapted to allow a user to automatically record single and multi-layered audio compositions. The multifunctional module may include a processing module 2806 that may be configured to: (a) capture a plurality of audio tracks from a user (e.g., via an audio capture device 2808), and/or (b) sequentially merge a currently captured audio track with one or more previously captured audio tracks in a user-controlled continuous loop where the one or more previously captured audio tracks are played to the user concurrent with capturing the current audio track from the user to thereby create an automatically engineered merged multi-layered audio composition. The continuously looped merging process auto-unifies the currently captured and the one or more previously captured audio tracks in a multi-layering operation. The multifunctional module may be configured to provide step-by-step interactive instructions to allow an untrained user to perform automated end-to-end audio capture, merging, and production. The multifunctional module may also be configured to reverse the merger of the currently captured audio track and one or more previously captured audio tracks based on user selections.

The one or more of the captured audio tracks may be merged with at least one of: pre-recorded audio by one or more users, an uploaded audio recording, and a captured video track. The multifunctional module may be further configured to play (via audio output device 2810, e.g., headphones) the one or more previously captured audio (e.g., stored in storage device 2812) while performing the looped audio capture and thereby automatically aligning the currently captured audio track with the one or more previously captured audio tracks prior to merging into the combined multi-layered composition. The currently captured audio track may be edited according to user selections prior to merging with the one or more previously captured audio tracks to obtain the multi-layered composition.

According to various examples, the merging of the currently captured audio track with the one or more previously captured audio tracks includes at least one of: (a) concurrently capturing a vocal track while merging the captured vocal track with one or more other vocal tracks to create the combined multi-layered composition, (b) concurrently capturing a vocal track while merging the captured vocal track with one or more pre-recorded captured instrumental tracks to create the combined multi-layered composition, (c) concurrently capturing an instrumental-type audio track while merging the captured instrumental-type audio track with one or more pre-recorded capture vocal tracks to create the combined multi-layered composition, (d) concurrently capturing an audio track while merging the captured audio track with a pre-stored karaoke-type tune to create the combined multi-layered composition, and/or (e) concurrently capturing an audio portion of an audio-video track while merging the audio portion with the plurality of previously captured audio tracks to create the combined multi-layered composition. The two or more merged tracks may be created by the same user or by different users. Consequently, the kiosk may be fully automated and operable to capture and record audio, review audio recordings, delete unwanted audio recordings, loop and merge the captured audio, and cancel merging of multiple captured audio tracks.

According to yet another feature, the multifunctional module may include (a) a recording device (e.g., audio capture device 2808) to capture the one or more previously captured audio tracks, (b) an editing device 2814 to edit the captured audio tracks according to user selections, and/or (c) a vending apparatus 2818 to collect payment from the user for use of the recording studio kiosk.

The multifunctional module may also include (a) a disk media recording device 2816 adapted to record one or more multi-layered audio compositions into a removable recording medium, (b) a network interface 2820 through which captured audio can be stored offsite, and/or (c) a communication port 2822 to couple to a removable storage device on which captured audio can be stored and from which user-provided audio can be uploaded.

Additionally, an audio-video capture device 2824 may be located within the recording chamber and coupled to the multifunctional module 2804 to capture audio and video, wherein an audio portion of an audio-video track captured by the audio-video capture device is automatically merged with a previously recorded multi-layered audio composition to produce an audio-video composition with a multi-layered audio composition.

A video display 2826 may be located on the outside of the external shell to display at least one of a captured user performance and instructional information for potential users. Additionally, an exterior user interface 2828 may be provided where recording options can be selected and previewed prior to entering the recording chamber. This allows users to minimize their time within the recording chamber, thereby allowing more users to use the recording studio kiosk.

The kiosk may also include a network interface 2820 to couple the multifunctional module to an external network and allow storage of the multi-layered composition to a central server. The multifunctional module may also be configured to allow a user to download at least one of: music selections, pre-recorded audio, user-provided audio, and audio recorded by other users via the network interface.

The multifunctional module may also be configured to collect at least one of: sales information for the kiosk, recording statistics for the kiosk, and/or music selection information for the kiosk that can be used to make profit sharing and royalty payments.

### Example Method for Operating Vending-Type Recording Studio Kiosk

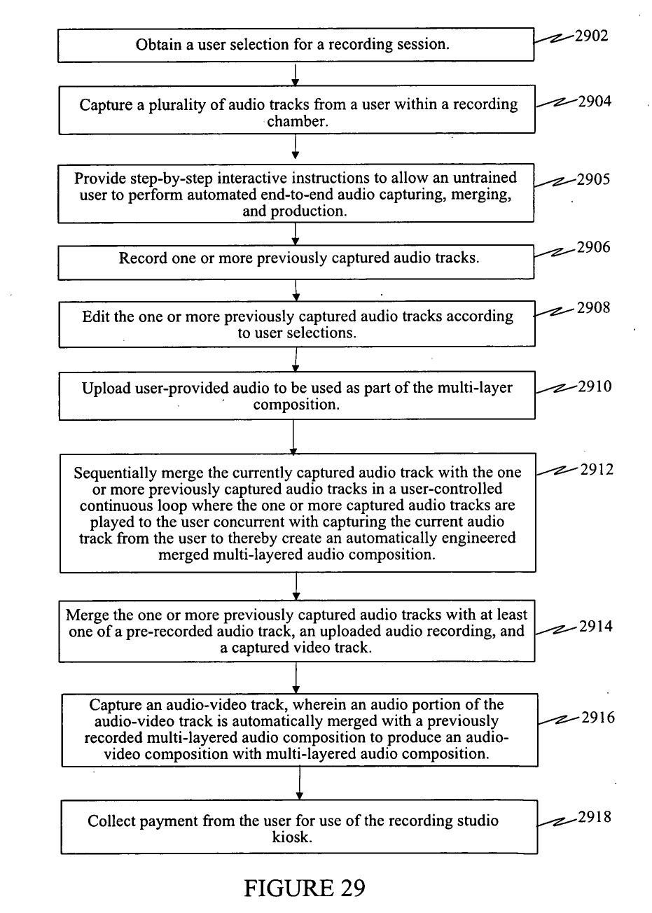

FIG. 29 illustrates a method for operating a vending-type recording studio kiosk. A user selection for a recording session is obtained 2902. A plurality of audio tracks are captured from a user within a recording chamber 2904. Step-by-step interactive instructions are provided by the vending kiosk to allow an untrained user to perform automated end-to-end audio capturing, merging, and production 2905. A currently captured audio track may be sequentially merged with one or more previously captured audio tracks in a user-controlled continuous loop where the one or more previously captured audio tracks are played to the user concurrent with capturing the current audio track from the user to thereby create an automatically engineered merged multi-layered audio composition 2912. The continuously looped merging process auto-unifies the currently captured and the one or more previously captured audio tracks in a multi-layering operation. The one or more previously captured audio tracks may be played to the user while performing the looped audio capture and thereby automatically aligning the currently captured audio track with the one or more previously captured audio tracks prior to merging into the combined multi-layered composition.

The method may include: (a) recording the one or more previously captured audio tracks 2906, (b) editing one or more audio tracks according to user selections 2908, and/or (c) collecting payment from the user for use of the recording studio kiosk 2918. In one example, the currently captured audio track may be edited according to user selections prior to merging with the previously captured audio tracks to obtain the multi-layered composition. Additionally, the merger of the currently captured audio track and one or more previously captured audio tracks may be reversed based on user selections.

Additionally, user-provided audio may also be uploaded to be used as part of the multi-layer composition 2910. The one or more previously captured audio tracks may also be merged with at least one of a pre-recorded audio track, an uploaded audio recording, and a captured video track 2914. Moreover, an audio-video track may also be captured, wherein an audio portion of the audio-video track is automatically merged with a previously recorded multi-layered audio composition to produce an audio-video composition with multi-layered audio composition 2916.

In various examples, merging the currently captured audio track with the one or more previously capture audio tracks includes at least one of: (a) concurrently capturing a vocal track while merging the captured vocal track with one or more other vocal tracks to create the combined multi-layered composition, (b) concurrently capturing a vocal track while merging the captured vocal track with one or more pre-recorded captured instrumental tracks to create the combined multi-layered composition, (c) concurrently capturing an instrumental-type audio track while merging the captured instrumental-type audio track with one or more pre-recorded capture vocal tracks to create the combined multi-layered composition, (d) concurrently capturing an audio track while merging the captured audio track with a pre-stored karaoke-type tune to create the combined multi-layered composition, and/or (d) concurrently capturing an audio portion of an audio-video track while merging the audio portion with the plurality of previously captured audio tracks to create the combined multi-layered composition.

In some implementations, recording options from the user may be obtained through an exterior user interface prior to entering the recording chamber.

Additionally, at least one of the following may be collected and/or transmitted by the kiosk: sales information for the kiosk, recording statistics for the kiosk, and music selection information for the kiosk that can be used to make profit sharing and royalty payments.

### Example of Network of Studio Kiosks

In another implementation, a portable recording studio system may be deployed including a plurality of portable vending-type recording studio kiosks. Each portable recording studio kiosk may be connected via an external network to a central server having a database. In one example, each portable recording studio kiosk may include: (a) an external shell, (b) a user system interface, and/or (c) a multifunctional module. The external shell may be made of sound-dampening material and define an interior recording chamber. The user system interface may be adapted to provide user instructions and receive user recording selections. The multifunctional module may be located within the recording chamber and controlled via the user system interface. The multifunctional module may be removable and/or interchangeable with other multifunctional modules. The multifunctional module may be configured to: (a) capture a plurality of audio tracks from a user within a recording chamber, and/or (b) sequentially merge a currently captured audio track with one or more previously captured audio tracks in a user-controlled continuous loop where the one or more previously captured audio tracks are played to the user concurrent with capturing the current audio track from the user to thereby create an automatically engineered merged multi-layered audio composition. Each portable recording studio kiosk is fully automated and operable to record songs performed by a user in the recording chamber, without assistance from another operator or sound engineer.

According to one feature, each portable recording studio kiosk may be configured to: (a) upload a performance recording to the database, (b) display data stored in the database on the user system interface, and/or (c) download a media track from the database to use with the multi-track recording equipment. Each portable recording studio kiosk may be remotely activated by the central server.

Example Method of Performing Contest with Studio Kiosks

In yet another implementation, a method for conducting a performance contest using portable recording studio kiosks is provided. A plurality of portable recording studio kiosks may be placed in a plurality of locations. The plurality of portable recording studio kiosks may be subsequently relocated to a plurality of new locations. The plurality of portable recording studio kiosks may be connected via a network to a central server having a database. Performances of different contestants may be recorded at the plurality of kiosks. The recorded performances are transmitted from the kiosks via the network to the central server for storage on the database. That is, the recorded performances from a plurality of portable recording studio kiosks may be aggregated in the central server. The recorded performances may then be judged by at least one judge.

One or more of the components, steps, and/or functions illustrated in the Figures may be rearranged and/or combined into a single component, step, or function or embodied in several components, steps, or functions without the features described herein. Additional elements, components, steps, and/or functions may also be added without departing from the invention. The novel algorithms described herein may be efficiently implemented in software and/or embedded hardware.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A vending-type recording studio kiosk, comprising:
an external shell having sound-dampening material and defining an interior recording chamber;
a user system interface to provide user instructions and receive user selections; and
a multifunctional module located within the recording chamber and controlled via the user system interface, wherein the multifunctional module is configured to:
capture a plurality of audio tracks from a user, and
sequentially merge a currently captured audio track with one or more previously captured audio tracks in a user-controlled continuous loop where the one or more previously captured audio tracks are played to the user concurrent with capturing the current audio track from the user to thereby create an automatically engineered merged multi-layered audio composition.

2. The kiosk of claim 1, wherein the multifunctional module includes:
an audio capture device to capture the one or more previously captured audio tracks;
an editing device to edit the captured audio tracks according to user selections; and
a vending apparatus to collect payment from the user for use of the recording studio kiosk.

3. The kiosk of claim 1, wherein the user system interface is integrated as part of the multifunctional module and provides multilingual support for instructions and selections in audio and visual forms.

4. The kiosk of claim 1, wherein the user system interface and multifunctional module are adapted to allow a user to automatically record single and multi-layered audio compositions.

5. The kiosk of claim 1, wherein the continuously looped merging process auto-unifies the currently captured and the one or more previously captured audio tracks in a multi-layering operation.

6. The kiosk of claim 1, wherein the multifunctional module is further configured to:
provide step-by-step interactive instructions to allow an untrained user to perform automated end-to-end audio capture, merging, and production.

7. The kiosk of claim 1, wherein the multifunctional module is further configured to:
reverse the merger of the currently captured audio track and one or more previously captured audio tracks.

8. The kiosk of claim 1, wherein the multifunctional module is further configured to:
merge the one or more captured audio tracks with at least one of: a pre-recorded audio by one or more users, an uploaded audio recording, and a captured video track.

9. The kiosk of claim 1, wherein the multifunctional module includes:
a disk media recording device adapted to record one or more multi-layered audio compositions into a removable recording medium;
a network interface through which captured audio can be stored offsite; and
a communication port to couple to a removable storage device on which captured audio can be stored and from which user-provided audio can be uploaded.

10. The kiosk of claim 1, wherein the multifunctional module is removable and interchangeable with another multifunctional module.

11. The kiosk of claim 1, further comprising:
an audio-video capture device located within the recording chamber and coupled to the multifunctional module to capture audio and video, wherein an audio portion of an audio-video track captured by the audio-video capture device is automatically merged with a previously recorded multi-layered audio composition to produce an audio-video composition with a multi-layered audio composition.

12. The kiosk of claim 11, further comprising:
a video display located on the outside of the external shell to display at least one of a captured user audio-video performance and instructional information for potential users.

13. The kiosk of claim 1, further comprising:
an exterior user interface where recording options can be selected and previewed prior to entering the recording chamber.

14. The kiosk of claim 1, wherein the kiosk is fully automated and operable to capture and record audio, review audio recordings, delete unwanted audio recordings, loop and merge the captured audio, and cancel merging of multiple captured audio tracks.

15. The kiosk of claim 1, wherein merging the currently captured audio track with the one or more previously capture audio tracks includes at least one of:
concurrently capturing a vocal track while merging the captured vocal track with one or more other vocal tracks to create the combined multi-layered composition;
concurrently capturing a vocal track while merging the captured vocal track with one or more pre-recorded captured instrumental tracks to create the combined multi-layered composition;
concurrently capturing an instrumental-type audio track while merging the captured instrumental-type audio track with one or more pre-recorded capture vocal tracks to create the combined multi-layered composition;
concurrently capturing an audio track while merging the captured audio track with a pre-stored karaoke-type tune to create the combined multi-layered composition; and
concurrently capturing an audio portion of an audio-video track while merging the audio portion with the plurality of previously captured audio tracks to create the combined multi-layered composition.

16. The kiosk of claim 15, wherein the two or more merged tracks are created by the same user.

17. The kiosk of claim 15, wherein the two or more merged tracks are created by different users.

18. The kiosk of claim 1, wherein the multifunctional module is further configured to:
play the one or more previously captured audio tracks while performing the looped audio capture and thereby automatically aligning the currently captured audio track with the one or more previously captured audio tracks prior to merging into the combined multi-layered composition.

19. The kiosk of claim 1, wherein the multifunctional module is further configured to:
edit the currently captured audio track according to user selections prior to merging with the previously captured audio tracks to obtain the multi-layered composition.

20. The kiosk of claim 1, further comprising:
a network interface to couple the multifunctional module to an external network and store the multi-layered composition to a central server.

21. The kiosk of claim 20, wherein a user downloads at least one of music selections, pre-recorded audio, user-provided audio, and audio recorded by other users via the network interface.

22. The kiosk of claim 20, wherein the multifunctional module is configured to collect at least one of:
sales information for the kiosk,
recording statistics for the kiosk, and
music selection information for the kiosk that can be used to make profit sharing and royalty payments.

23. A method for operating a vending-type recording studio kiosk, comprising:
obtaining a user selection for a recording session;
capturing a plurality of audio tracks from a user within a recording chamber; and
sequentially merge a currently captured audio track with one or more previously captured audio tracks in a user-controlled continuous loop where the one or more previously captured audio tracks are played to the user concurrent with capturing the current audio track from the user to thereby create an automatically engineered merged multi-layered audio composition.

24. The method of claim 23, further comprising:
uploading user-provided audio to be used as part of the multi-layer composition.

25. The method of claim 23, wherein the continuously looped merging process auto-unifies the currently captured and the one or more previously captured audio tracks in a multi-layering operation.

26. The method of claim 23, further comprising:
providing step-by-step interactive instructions to allow an untrained user to perform automated end-to-end audio capturing, merging, and production.

27. The method of claim 23, further comprising:
reversing the merger of the currently captured audio track and one or more previously captured audio tracks according to user selections.

28. The method of claim 23, further comprising:
merging the one or more captured audio tracks with at least one of a pre-recorded audio track, an uploaded audio recording, and a captured video track.

29. The method of claim 23, further comprising:
capturing an audio-video track, wherein an audio portion of the audio-video track is automatically merged with a previously recorded multi-layered audio composition to produce an audio-video composition with multi-layered audio composition.

30. The method of claim 23, wherein merging the currently captured audio track with the one or more previously capture audio tracks includes at least one of:
concurrently capturing a vocal track while merging the captured vocal track with one or more other vocal tracks to create the combined multi-layered composition;
concurrently capturing a vocal track while merging the captured vocal track with one or more pre-recorded captured instrumental tracks to create the combined multi-layered composition;
concurrently capturing an instrumental-type audio track while merging the captured instrumental-type audio track with one or more pre-recorded capture vocal tracks to create the combined multi-layered composition;
concurrently capturing an audio track while merging the captured audio track with a pre-stored karaoke-type tune to create the combined multi-layered composition; and
concurrently capturing an audio portion of an audio-video track while merging the audio portion with the plurality of previously captured audio tracks to create the combined multi-layered composition.

31. The method of claim 23, further comprising:
obtaining recording options from the user through an exterior user interface prior to entering the recording chamber.

32. The method of claim 23, further comprising:
playing the one or more previously captured audio tracks while performing the looped audio capture and thereby automatically aligning the currently captured audio track with the one or more previously captured audio tracks prior to merging into the combined multi-layered composition.

33. The method of claim 23, further comprising:
editing the currently captured audio track according to user selections prior to merging with the previously captured audio tracks to obtain the multi-layered composition.

34. A vending-type multifunctional recording module, comprising:
means for obtaining a user selection for a recording session;
means for capturing a plurality of audio tracks from a user within a recording chamber; and
means for sequentially merge a currently captured audio track with one or more previously captured audio tracks in a user-controlled continuous loop where the one or more previously captured audio tracks are played to the user concurrent with capturing the current audio track from the user to thereby create an automatically engineered merged multi-layered audio composition.

35. The module of claim 34, further comprising:
means for providing step-by-step interactive instructions to allow an untrained user to perform automated end-to-end audio capturing, merging, and production.

36. A multifunctional audio recording module, comprising:
a user system interface to provide user instructions and receive user selections; and
an audio capture device for capturing a plurality of audio tracks from a user, and
a processing module configured to sequentially merge a currently captured audio track with one or more previously captured audio tracks in a user-controlled continuous loop where the one or more previously captured audio tracks are played to the user concurrent with capturing the current audio track from the user to thereby create an automatically engineered merged multi-layered audio composition.

37. The module of claim 36, further comprising:
a recording device to capture the one or more previously captured audio tracks;
an editing device to edit the captured audio tracks according to user selections; and
a vending apparatus to collect payment from the user for use of the recording studio kiosk.

38. The module of claim 36, wherein the processing module is further configured to:
provide step-by-step interactive instructions via the user interface to allow an untrained user to perform automated end-to-end audio capture, merging, and production.

39. The module of claim 36, wherein the processing module is fully automated and operable to capture and record audio, review audio recordings, delete unwanted audio recordings, loop and merge the captured audio, and cancel merging of multiple captured audio tracks.

40. The module of claim 36, wherein the processing module is further configured to:
play the one or more previously captured audio tracks while performing the looped audio capture and thereby automatically aligning the currently captured audio track with the one or more previously captured audio tracks prior to merging into the combined multi-layered composition.
